(19) United States
(12) Patent Application Publication
(10) Pub. No.: US 2008/0094616 A1
(43) Pub. Date: Apr. 24, 2008

(54) Surface defect inspection apparatus

(75) Inventor: Toshihiko Tanaka, Yokohama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/986,699

(22) Filed: Nov. 26, 2007

Related U.S. Application Data
(63) Continuation of application No. PCT/JP2006/310369, filed on May 24, 2006.

(30) Foreign Application Priority Data
May 25, 2005 (JP) P2005-152003

(51) Int. Cl. G01N 21/00

(52) U.S. Cl. 356/237.2

(57) ABSTRACT

A surface defect inspection apparatus in accordance with the present invention is a surface defect inspection apparatus 500 which includes a tested object 40 a multi-layer film is formed on the surface thereof, and an illumination portion 5 which irradiates an illumination light 6b generated by the illumination lamp 41 onto the tested object 40 so that the image of the tested object irradiated with the illumination light 6b to detect a surface defect of the tested object 40 is visually observable by an observer 49. A wavelength distribution of the illumination light 6b is corrected so that the light intensity is substantially constant with respect to the wavelength sensitivity characteristics of the human eye. In accordance with the present invention, in a case of inspecting a tested object formed with a multi-layer film, even with a difference in film thickness in lower layers, unevenness in brightness or color of the surface hardly occurs, whereby it is possible to improve the detection accuracy of defects.

This application is a continuation application based on a PCT Patent Application No. PCT/JP2006/310369, filed on May 24, 2006, whose priority is claimed on Japanese Patent Application No. 2005-152003 filed on May 25, 2005. The contents of both the PCT Application and the Japanese Application are incorporated herein by reference.

### TECHNICAL FIELD

The present invention relates to a surface defect inspection apparatus. More specifically, the present invention relates to a surface defect inspection apparatus which irradiates illumination light onto tested objects such as semiconductor wafer, liquid crystal glass substrate or the like and inspects surface defects.

### BACKGROUND ART

Conventionally, in manufacturing process such as for semiconductor wafer or liquid crystal glass substrate or the like, a Multi-layer substrate provided with patterned resists is formed during the process on a substrate made of silicon or glass plate via a film-forming layer.

However, in a photolithography process, when unevenness in film is formed or dust is attached on a resist applied on the substrate surface, defects such as failures of line width in the pattern formed after etching or pinholes in the pattern are generated.

Because of this, usually inspection is performed whether such defects exist or not before etching the substrate.

As a method of inspection, a visual inspection method on the substrate by operators is often used, since dust originating from the body of the operators cannot be ignored even in a clean room, methods which separate operators from the substrate as far as possible have been proposed.

Also, when the operators get tired, judgment tends to fluctuates and therefore, it has been proposed that judgment of defects be performed by apparatuses. For example, in Japanese unexamined patent application, first publication, No. H07-27709 (page 5 to 10, FIG. 1), a surface defect inspection apparatus which makes it possible to irradiate line light flux from the circumference of the substantially parallel light flux is disclosed. As a light source of this illumination, a constitution which is formed by a lamp house having a halogen lamp, a heat-absorbing filter, and a condenser lens thereinside is used to generate a white light. These are designed so that the white light is illuminated as a narrow-banded light by the white light and an interference filter. The interference filter is designed so that a center wavelength can be selected with 10 nm intervals from the range of 550 nm to 650 mm. Also, in Japanese unexamined patent application, first publication, No. H09-061365 (page 4 to 6, FIGS. 1 to 3), a surface defect inspection apparatus which disposes a line illumination portion and a line image capturing portion so that mutual angles are variable and are moved on the surface of the tested object and image captures reflected light, diffracted light, and scattering light of illumination light, whereby detecting defects based on these images by image processing. In an illumination portion, as a light source, a constitution which is formed by a lamp house having a halogen lamp, a heat-absorbing filter, and a condenser lens thereinside is used to generate white light. Also as a light system for illumination, a constitution formed by an interference filter, a condensing lens, and a fiber bundle which narrow-bands the white light from the lamp house is used.

With this apparatuses, defects in lateral surface shape of resist in its thickness direction are detected by scattering light when the convergent light is irradiated.

Also, in Japanese unexamined patent application, first publication, No. H07-229832 (page 3 to 4, FIGS. 1 to 5), a surface inspection apparatus which performs inspection by obtaining a light and dark pattern emphasized with unevenness in brilliance by making an illumination light, which entered the inspection object, to be specularly reflected by a specular reflection portion and to be re-directed to the inspection object is disclosed.

### DISCLOSURE OF THE INVENTION

### Problem to be Solved by the Invention

### Means for Solving the Problems

A first aspect of a surface defect inspection apparatus in accordance with the present invention is a surface defect inspection apparatus which includes an illumination portion that irradiates illumination light generated by a light source onto a tested object with a multi-layer film formed on the surface thereof, and makes it possible either to visually observe or image capture the tested object irradiated by the illumination light to inspect surface defects of the tested object in which a light intensity of the light irradiated from the illumination portion and received by the human eye or an output intensity of image signal corresponding to a light intensity received by the image capturing portion, that is the light received by the human eye or the image capturing portion, is corrected to be substantially constant under a wavelength sensitivity characteristic of the human eye or image capturing portion.

A second aspect of the surface defect inspection apparatus in accordance with the present invention is a surface defect inspection apparatus in accordance with the first aspect in which the light irradiated from the illumination portion has peaks in a plurality of wavelengths and the light intensity of the light irradiated from the illumination portion is corrected to make the output intensity of the image signal corresponding to the intensity at which the human eye can sense or the light intensity received by the image capturing portion which corresponds to the peak intensities of the pluralities of the wavelengths substantially constant.

A third aspect of the surface defect inspection apparatus in accordance with the present invention is a surface defect inspection apparatus in accordance with the first aspect in which the light intensity of the light irradiated from the illumination portion and received and sensed by the human eye or the light intensity received by the image capturing portion is corrected based on the wavelength sensitivity characteristics of the human eye or image capturing portion, or light distribution of the illumination light.

A fourth aspect of the surface defect inspection apparatus in accordance with the present invention is a surface defect inspection apparatus in accordance with the first aspect in which an output intensity of the image signal corresponding to the light intensity of the light irradiated from the illumination portion and received and sensed by the human eye or light intensity received by the image capturing portion is corrected to be substantially constant by an wavelength sensitivity correction filter which corrects based on the wavelength sensitivity characteristics of the human eye or image capturing portion or wavelength distribution of illumination light.

A fifth aspect of the surface defect inspection apparatus in accordance with the present invention is a surface defect inspection apparatus in accordance with the first aspect in which the light source of the illumination portion has a different wavelength distribution and formed by a plurality of light sources the light quantity of which are variable independently of each other, and based on the wavelength sensitivity characteristics of the human eye or image capturing portion, the light intensity or the balance of the light quantity of the plurality of the light sources is changed so that the light intensity of the light irradiated from the illumination portion and received and sensed by the human eye or the output intensity of image signal corresponding to the light intensity received by the image capturing portion is substantially constant.

A sixth aspect of the surface defect inspection apparatus in accordance with the present invention is a surface defect inspection apparatus in accordance with the first aspect in which the wavelength distribution of the illumination light is corrected corresponding to the spectral luminous efficiency characteristics of the human eye to make the light intensity that an observer senses substantially constant under the wavelength sensitivity characteristics of the human eye.

A seventh aspect of the surface defect inspection apparatus in accordance with the present invention is a surface defect inspection apparatus in accordance with the first aspect which includes a light path for visually observing the image of the tested object irradiated with the illumination light and a light path for imaging the same and also a light path switching portion which switches between the light path for visual observation and the light path for imaging, in which the wave distribution of the illumination light is switched according to the switching operation of the light path switching portion.

An eighth aspect of the surface defect inspection apparatus in accordance with the present invention is a surface defect inspection apparatus in accordance with the first aspect which includes a first polarization plate, which is placed on a light path between the light source of the illumination portion and the tested object, and a second polarization plate, which is placed on a light path between the tested object and the human eye or the image capturing portion.

A ninth aspect of the surface defect inspection apparatus in accordance with the present invention is a surface defect inspection apparatus in accordance with the first aspect which includes a re-reflection optical system provided with at least a reflection element which makes the illumination light reflected by the tested object re-directs the position on which the illumination light was reflected and makes it possible to observe the light reflected two times or more on the same position on the tested object by the human eye or the image capturing portion.

A tenth aspect of the surface defect inspection apparatus in accordance with the present invention is a surface defect inspection apparatus in accordance with the first aspect in which an optical element which elongates and contracts the image of the tested object in only one direction is placed on a light path, on which the illumination light is reflected from the tested object for the last time and enters the human eye or the image capturing portion.

An eleventh aspect of the surface defect inspection apparatus in accordance with the present invention is a surface defect inspection apparatus in accordance with the first aspect in which a translucent screen formed with a reference pattern to align the image of the tested object is provided between the tested object and the position where the visual observation is performed.

A twelfth aspect of the surface defect inspection apparatus in accordance with the present invention is a surface inspection apparatus in accordance with the first aspect in which the image capturing portion is a line image capturing portion which image captures the tested object as a line and is provided with a retaining portion movably placed in a direction perpendicular to a longitudinal direction of the line image capturing region of the line image capturing portion.

A thirteenth aspect of the surface defect inspection apparatus in accordance with the present invention is a surface inspection apparatus in accordance with the ninth aspect in which at least the illumination portion or the re-reflection optical system is retained by an angle varying mechanism which varies the angle position of the light axis relative to the surface of the tested object.

### EFFECTS OF THE INVENTION

### Brief Description of Drawings

FIG. 1A is a front view showing a schematic view of a general construction of the surface defect inspection apparatus of the reference example viewed visually.

FIG. 1B is a side explanatory diagram visually viewed from arrow A of a translucent screen used for the surface defect inspection apparatus of the reference example.

FIG. 2 is a graph to explain the wavelength distribution of a light source of the surface defect inspection apparatus of the reference example viewed visually.

FIG. 3 is a graph to explain the wavelength characteristics of a wavelength sensitivity correction filter used for surface defect inspection apparatus of the reference example viewed visually.

FIG. 4 is a graph to explain the wavelength distribution of the light source of the surface defect inspection apparatus of the reference example viewed visually.

FIG. 5 is a graph to explain the wavelength distribution of a substantially white light sensed by an observer by the surface defect inspection apparatus of the reference example viewed visually.

FIG. 6A is a schematic view in cross sectional direction of the multi-layer film to explain the reflectance of the multi-layer film.

FIG. 6B is a schematic view in cross sectional direction of the multi-layer film to explain the reflectance of the multi-layer film.

FIG. 7 is a graph showing an example of numerical calculation to explain the change in reflectance due to the thickness of the multi-layer film.

FIG. 8 is a graph to explain reflection characteristics relative to the white light when the lower layers of the multi-layer film are made constant.

FIG. 9 is a graph to explain an incident angle dependency of the reflectance in accordance with a polarization state.

FIG. 10A is a schematic view of sectional view in layer thickness direction of a normal pattern formed on the top layer.

FIG. 10B is a schematic view of sectional view in layer thickness direction of an abnormal pattern formed on the top layer.

FIG. 11 is a graph to explain the incident angle dependency of the reflectance when the multi-layer film have a refractive index distribution.

FIG. 12 is a schematic front view of the general construction of the surface defect inspection apparatus of the first embodiment of the present invention.

FIG. 13A is a light path diagram shown in a schematic view to explain one example of lens constitutions of projection correction lens used for the surface defect inspection apparatus of the first embodiment of the present invention.

FIG. 13B is a light path diagram shown in a schematic view to explain movement of the projection correction lens used for the surface defect inspection apparatus of the first embodiment of the present invention.

FIG. 14A is an explanatory diagram viewed from a normal line direction to explain a reticle mark of a front glass used for the surface defect inspection apparatus of the first embodiment of the present invention.

FIG. 14B is an explanatory diagram viewed from a normal line direction to explain a reticle mark of a half mirror used for the surface defect inspection apparatus of the first embodiment of the present invention.

FIG. 15 is a schematic front view of the general construction of the surface defect inspection apparatus in accordance with the first modification example of the first embodiment of the present invention.

FIG. 16 is a schematic front view of the general construction of the surface defect inspection apparatus of the second embodiment of the present invention.

FIG. 17 is a schematic front view of the general construction of the surface defect inspection apparatus in accordance with the first modification example of the second embodiment of the present invention.

FIG. 18 is a schematic front view of the general construction of the surface defect inspection apparatus in accordance with the second modification example of the second embodiment of the present invention.

FIG. 19 is a schematic plain view of the general construction of the surface defect inspection apparatus in accordance with the second modification example of the second embodiment of the present invention.

FIG. 20 is a schematic front view of the general construction of the surface defect inspection apparatus in accordance with the third modification example of the second embodiment of the present invention.

FIG. 21 is a schematic front view of the general construction of the surface defect inspection apparatus in accordance with the fourth modification example of the second embodiment of the present invention.

FIG. 22A is a schematic front view of the general construction of the surface defect inspection apparatus in accordance with the fifth modification example of the second embodiment of the present invention.

FIG. 22B is a schematic plain view of the general construction of the surface defect inspection apparatus in accordance with the fifth modification example of the second embodiment of the present invention.

FIG. 23A is a schematic front view of the general construction of the surface defect inspection apparatus in accordance with the sixth modification example of the second embodiment of the present invention.

FIG. 23B is a schematic plain view of the general construction of the surface defect inspection apparatus in accordance with the sixth modification example of the second embodiment of the present invention.

FIG. 24A is a schematic front view of the general construction of the surface defect inspection apparatus in accordance with the seventh modification example of the second embodiment of the present invention.

FIG. 24B is a schematic plain view of the general construction of the surface defect inspection apparatus in accordance with the seventh modification example of the second embodiment of the present invention.

FIG. 25A is a schematic front view of the general construction of the surface defect inspection apparatus in accordance with the eighth modification example of the second embodiment of the present invention.

FIG. 25B is a schematic plain view of the general construction of the surface defect inspection apparatus in accordance with the eighth modification example of the second embodiment of the present invention.

FIG. 26 is a schematic front view of the general construction of the surface defect inspection apparatus in accordance with the ninth modification example of the second embodiment of the present invention.

FIG. 27A is a front view of an explanatory movement diagram showing the movement of the surface defect inspection apparatus in accordance with the ninth modification example of the second embodiment of the present invention.

FIG. 27B is a front view of an explanatory movement diagram showing the movement of the surface defect inspection apparatus in accordance with the ninth modification example of the second embodiment of the present invention.

FIG. 28A is a schematic front view of the general construction of the surface defect inspection apparatus in accordance with the tenth modification example of the second embodiment of the present invention.

FIG. 28B is a schematic front view of the general construction of the surface defect inspection apparatus in accordance with the eleventh modification example of the second embodiment of the present invention.

FIG. 29 is an explanatory schematic front view to explain other illumination portions which can be used for each of the embodiments of the present invention.

### BRIEF DESCRIPTION OF THE REFERENCE NUMERALS

5, 50, 51, 51A, 52, 53, 53A, 54 illumination portion
6a, 6b, 6c, 126a, 126b, 126c, 152 illumination light
7 reflected light
8, 137b re-reflected light
40 tested object
41, 125 illumination lamp (light source)
43 compensation filter (wavelength sensitivity correction filter)
44A polarization plate (first polarization plate)
44B polarization plate (second polarization plate)
45, 92 collimating lens (irradiation optical system)
46 rotating mechanism (retaining portion)
47, 95 front glass (translucent screen)
47a, 97a, 97b, 98a, 98b reticle mark (reference pattern)
48 polarization plate movement mechanism
49 observer
91 half mirror (translucent screen)
93, 113, 128, mirror (reflection element)
94, 601 projection correction lens (an optical element which elongates and contracts the image of the tested object only in one direction)
101 control portion
102 mirror (light path switching portion)
104 image capturing element (image capturing portion)
105 laser emitting diode (light source)
107 wavelength compensation plate (wavelength sensitivity correction filter)
110, 111 deflection mirror
112, 127 field mirror (illumination optical system)
117 specimen support
119 image processing portion
121 apparatus control portion
123 light detection element (image capturing portion)
124 wavelength compensation filter (wavelength sensitivity correction filter)
129 supplementary illumination portion
130 light guiding member
131 line image capturing element (image capturing portion)
132 line illumination lamp (light source)
140A, 140C paraboloid mirror
140B paraboloid mirror (reflection element)
141 illumination condensing lens
150 LED
200 laser beam (illumination light)
500, 501, 501A, 502, 503, 504, 505, 506, 507, 508, 509, 510, 510A surface defect
inspection apparatus
600 projection correction lens movement portion
602 electrical-powered scattering plate
603 field lens (illumination optical system)
604 concave mirror (reflection element)
G1 first lens group
G2 second lens group

### BEST MODE FOR CARRYING OUT THE INVENTION

Hereinbelow, the embodiments of the present invention shall be explained referring to the attached drawings. In all of the drawings, identical or corresponding members are denoted with identical reference numerals and explanations of those reference numerals having the same meanings are omitted in the explanations of different embodiments.

Before explaining the surface defect inspection apparatus in accordance with the first embodiment of the present invention, defect detection accuracy deterioration prevention will be explained by using the visually viewed surface defect inspection apparatus of the reference example.

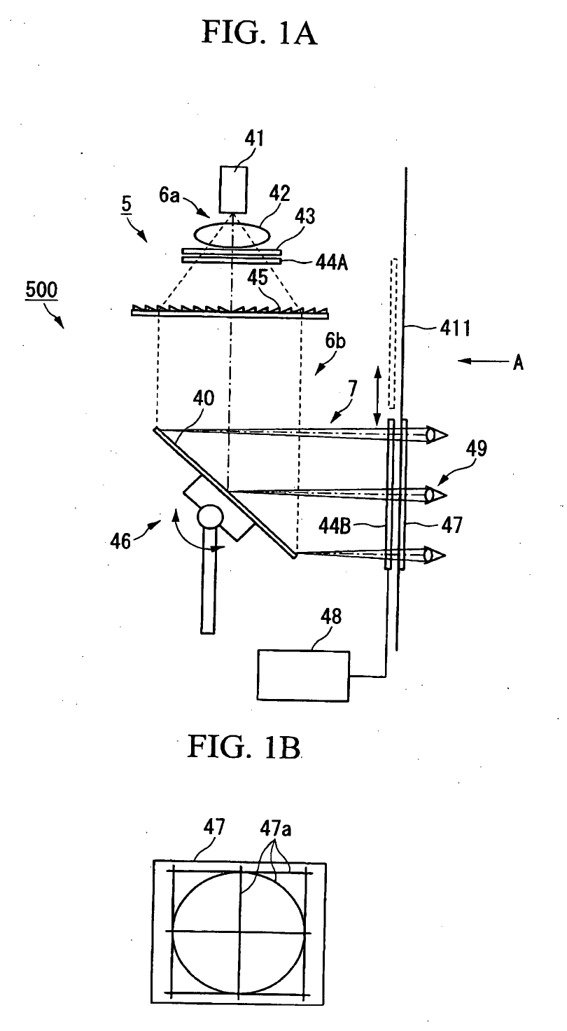

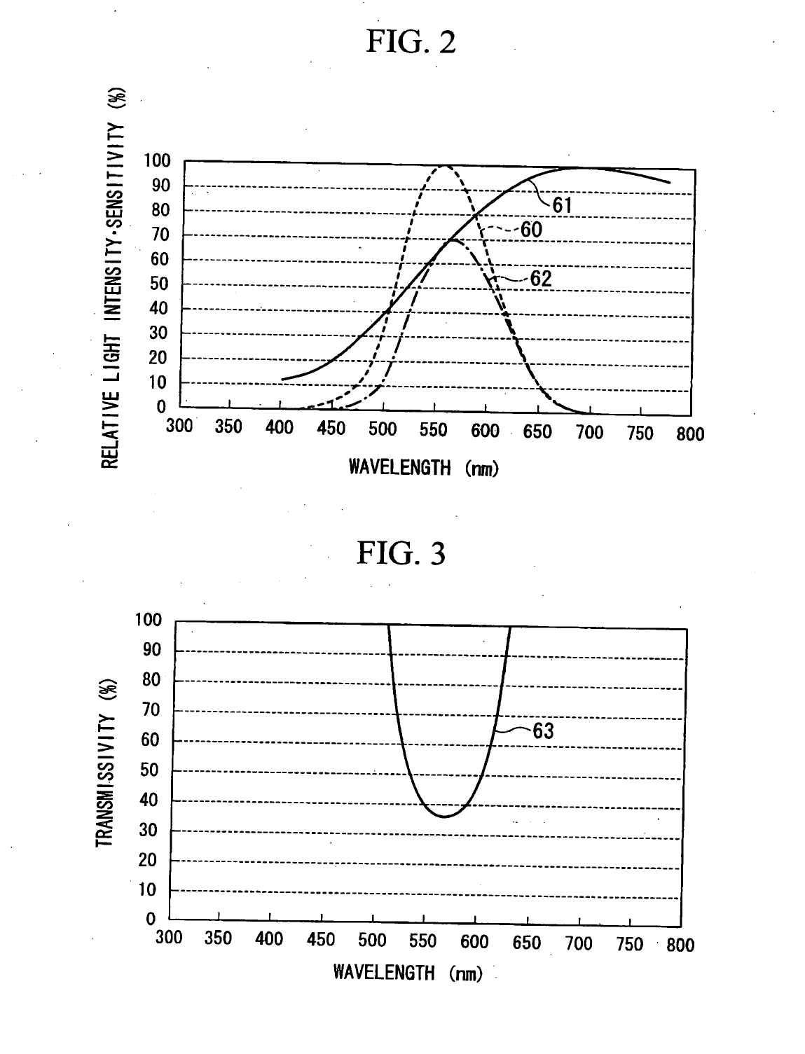

FIG. 1A is a schematic front view of the general construction of the surface defect inspection apparatus of the reference example viewed visually. FIG. 1B is a side explanatory diagram visually viewed from arrow A in FIG. 1A of a translucent screen used for the surface defect inspection apparatus of the reference example. FIG. 2 is a graph to explain the wavelength distribution of a light source of the surface defect inspection apparatus of the reference example viewed visually. The horizontal axis shows the wavelength (in nano meters) (common in FIG. 2 to FIG. 5). The vertical axis shows light intensity on its left side and luminous efficiency on its right side. FIG. 3 is a graph to explain the wavelength characteristics of a wavelength sensitivity correction filter used for surface defect inspection apparatus of the reference example viewed visually. The vertical axis shows transmissivity (in percent).

As shown in FIG. 1A, a surface defect inspection apparatus 500 of the reference example is an apparatus to inspect surface defects by, for example, irradiating illumination light 6b onto a tested object 40 formed of a substrate such as a semiconductor wafer or a liquid crystal glass substrate or the like formed with a multi-layer film and visually observing its reflected light 7. The outer shape of the tested object 40 may be any arbitrary shape such as a rectangle or the like. Hereinbelow, explanation will be given by regarding the tested object 40 as a substrate with a circular outer shape in plain view.

A general construction of the surface defect inspection apparatus 500 includes an illumination portion 5, rotating mechanism 46 (retaining portion), and a polarization plate (second polarization plate) covered by a partition wall portion 411, a part of which is provided with a front glass 47 (translucent screen).

The illumination portion 5 includes an illumination lamp 41 (light source) which generates illumination light 6a which is a divergent light, a condensing lens 42 which condenses illumination light 6a, a compensation filter 43 (wavelength sensitivity correction filter) which corrects wavelength distribution of the illumination light 6a so that it is sensed as substantially white light when viewed visually, a polarization plate 44A (first polarization plate), and a collimating lens 45 (irradiation optical system) which converts illumination light 6a into parallel light with all of these arranged in series on a light axis of the illumination lamp 41.

The illumination lamp 41 is a light source having a continuous spectrum at least in optical wavelengths (380 nm to 770 nm) in which a halogen lamp or the like can be used for example.

A simple overview of a figure of the wavelength distribution of the illumination lamp 41 is shown in FIG. 2 as a curve 61. That is, with a light source with a higher color temperature such as a halogen lamp, as shown with the curve 61, the light intensity simply increases from the short wavelength side of optical wavelengths to the long wavelength side and has such a wavelength distribution that it continues to increase in infrared wavelengths as well. Therefore, the light has more red than the white light.

When visually viewed, the illumination lamp 6a irradiated from such a illumination lamp 41 is sensed as a light having a wavelength distribution of a bell shape in which the peak wavelength of 570 nm is slightly shifted to the long wavelength side since human spectral luminous efficiency has a wavelength sensitivity characteristic of a bell shape having its peak at about 550 nm as shown with a curve 60 in FIG. 2. Therefore, the light of the wavelength characteristics of the illumination lamp 41 has a relatively strong redness which is sensed as a light seen yellowish when visually viewed.

The compensation filter 43 is a filter provided with a wavelength characteristic as shown in a curve 63 in FIG. 3. That is, it has a wavelength characteristic shown in a substantially V shape which is a bell shape turned upside down in which it has high transmissivity on the short wavelength side and the long wavelength side of optical wavelength region and it has low transmissivity at a region therebetween with its minimum value at a wavelength of about 570 nm.

The polarization plate 44A and 44B are to control the polarization state of the illumination light 6a and the reflected light 7 respectively. The polarization plate 44A is arranged so as to direct the polarization state at a predetermined direction when the illumination light 6a is converted to a parallel light by the collimating lens 45 and entered the tested object 40 as the illumination light 6b. For example, it is arranged so that the illumination light 6b is entered as the s-polarized light.

The polarization plate 44B is made to formed so as to be extendable and retractable relative to a light path of the reflected light 7 and to move rotatably with a light axis of the reflected light 7 as its rotation center due to a polarization plate movement mechanism 48 which is formed with an arbitral actuator, a rotational stage, or the like.

Therefore, when the polarization plate 44B is extended to the light path of the reflected light 7, it is made so that an observer 49 can only visually observe a predetermined polarization component due to a positional relationship with the polarization plate 44A.

A Fresnel lens in which the thickness of the lens can be made thin is employed for the collimating lens 45 as shown in FIG. 1A in this embodiment although it may be constituted with a convex lens.

The front glass 47 is an optical opening portion placed in the partition wall portion 411 which allows the reflected light 7 to transmit therethrough and allows the observer 49 to visually observe the image of the tested object 40 from outside of the partition wall portion 411.

Also as shown in FIG. 1B, a reticle mark 47a such as scale marks of a grid pattern, cross marks, circle marks, ellipse marks, alignment marks or the like in accordance with the shape or size of the tested object 40 is formed so that a position of the observed defect can be easily identified as a position on the tested object 40.

Next, a movement by visual observation of the surface defect inspection apparatus 500 will be explained.

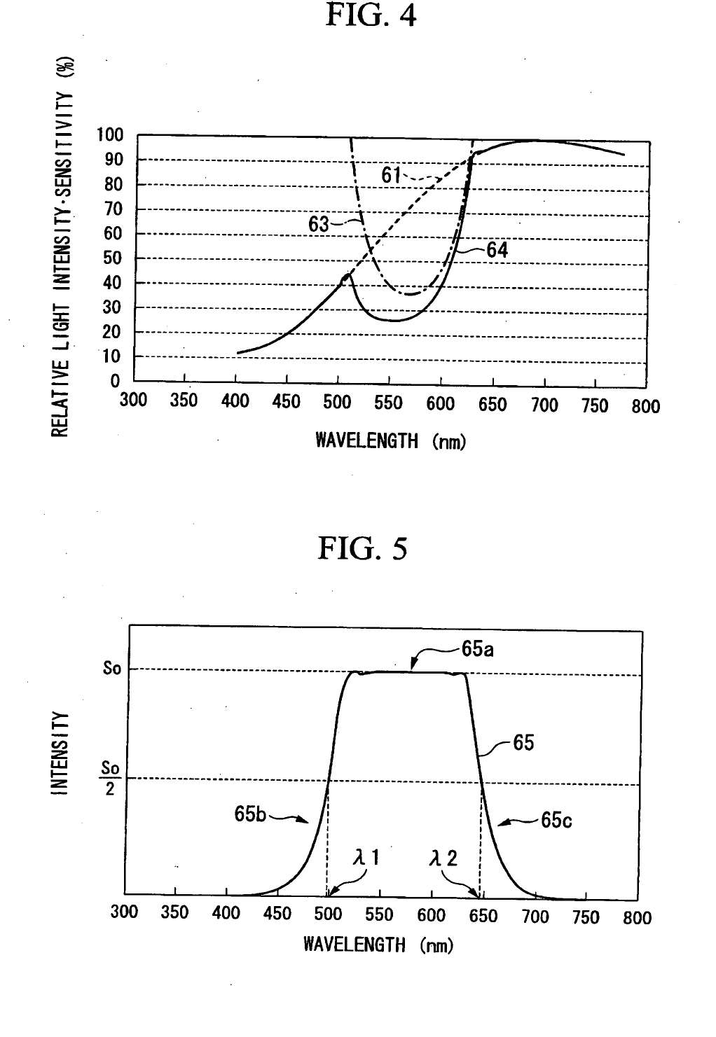

FIG. 4 is a graph to explain a wavelength distribution of the light source of the surface defect inspection apparatus of the reference example viewed visually. FIG. 5 is a graph to explain a wavelength distribution, in which the light intensity (output intensity) is substantially even, sensed by an observer by way of the surface defect inspection apparatus of the reference example viewed visually. Here, the horizontal axis shows wavelength (in nano meters) (common in FIGS. 4 and 5). The left side of FIG. 4 shows the relative light intensity of the light source and transitivity. The vertical axis of FIG. 5 shows the light intensity a person can sense.

As shown in FIG. 1A, the illumination light 6a irradiated from the illumination lamp 41 is condensed by the condensing lens 42, transmits the compensation filter 43, and the wavelength distribution is corrected. That is, as shown in FIG. 4, the wavelength distribution of the light intensity shown with the curve 61 is corrected to a characteristic as shown with a curve 64 so that it has a maximum value at about 510 nm and has a minimum value at about 555 nm. The light intensity simply increases at the higher wavelength side than those wavelengths due to a transparent wavelength characteristics (refer curve 63) of the compensation filter 43.

The plane of vibration of light of the illumination light 6a is aligned to a perpendicular direction to the surface of the drawing paper by secondly transmitting the polarization plate 44A and the illumination light 6a enters a polarization state which is the s-polarized light relative to the tested object 40. Then the illumination light 6a is converted to a parallel light by the collimating lens 45 whereby it enters the tested object 40 as the illumination light 6b.

The reflected light 7 reflected by the tested object 40 is output outside of the partition wall portion 411 passing through the front glass 47 in which only a predetermined polarization component transmits due to the polarization plate 44B when the polarization plate 44B is extended to the light path.

Here, the polarization plate 44B may be retracted from the light pass of the reflected light 7 by the polarization plate movement mechanism 48 so that the reflected light does not pass through the polarization plate 44B when it is not necessary to control the polarization state due to object or the like for defect detection.

In accordance with necessity, by operating the rotating mechanism 46, the observer 49 may place the tested object 40 by rotatably moving the tested object 40 so that the defect is easy to be seen.

Since a reticle mark 47a is formed on the front glass 47, it facilitates the identification of a position where a defect is confirmed or to select a position to be observed by aligning the outer shape or image of the tested object 40 to the reticle mark 47a.

Also, a transparent glass plate may be placed between the front glass 47 and the rotating mechanism 46 so that a position on the light axis becomes identical and the reticle mark identical to the reticle mark 47a of the front glass may be formed thereon. It is possible to observe by placing the position of the operator's eyes with a good reproducibility by observing with the eyes moving such that the reticle mark and the reticle mark 47a overlap.

As shown in FIG. 1A, the tested object 40 with a circular outer shape is seen as an elliptical shape when observed from diagonal direction, as the reticle mark 47a, it may be a mark of the grid pattern or the like so that the elliptical shape, which is arranged to a position of swing angle of frequent use, or its major axis or minor axis can be aligned.

When the light observed by the observer 49 is a specular reflection light, changes in shape of the surface pattern of the tested object 40 are included in the reflected light 7 as information on brightness and it is possible to observe by relating information on defects on the surface to such information on the brightness of the surface pattern. However, even when observing dark field images or the like in which such information is not detected, it has advantages in identifying observation positions of the defects or to facilitate selecting positions to be observed due to the reticle mark 47a.

In those visual observations of reference examples, the illumination light 6b is corrected by the compensation filter 43 based on the spectral luminous efficiency characteristics and the wavelength distribution of the illumination lamp 41. Because of this, to the observer 49, the light intensity of the illumination light 6b is sensed as being substantially even along the optical wavelength range. That is, the wavelength characteristic of the illumination light 6b is corrected to a wavelength characteristic of the curve 64 in FIG. 4 whereby it is sensed by the observer 49 as substantially even light intensity distribution of a curve 65 shown in FIG. 5.

The curve 65 has a substantially rectangular wave shaped distribution formed by strongly-sloped portions 65b, 65c in which λ₁=about 500 nm, λ₂=about 640 nm and a flat portion 65a in which most of the portion is close to S₀ therebetween when the half value intensity wavelengths are denoted as λ₁, λ₂ relative to a peak intensity S₀. That is, it is sensed that most of the light wavelength has substantially the same intensity between the wavelengths λ₁ and λ₂.

In this way, in the surface defect inspection apparatus 500 of the reference example, the illumination light 6b is sensed as light of substantially even intensity along the optical wavelength range to the observer 49 and the polarization state is controlled to become s-polarized light. Each of the operations will be explained hereinbelow.

Explanation is given in the case in which the tested object 40 makes film of Si₃N₄ on the silicon substrate and a photoresist film is further formed thereon, as an example.

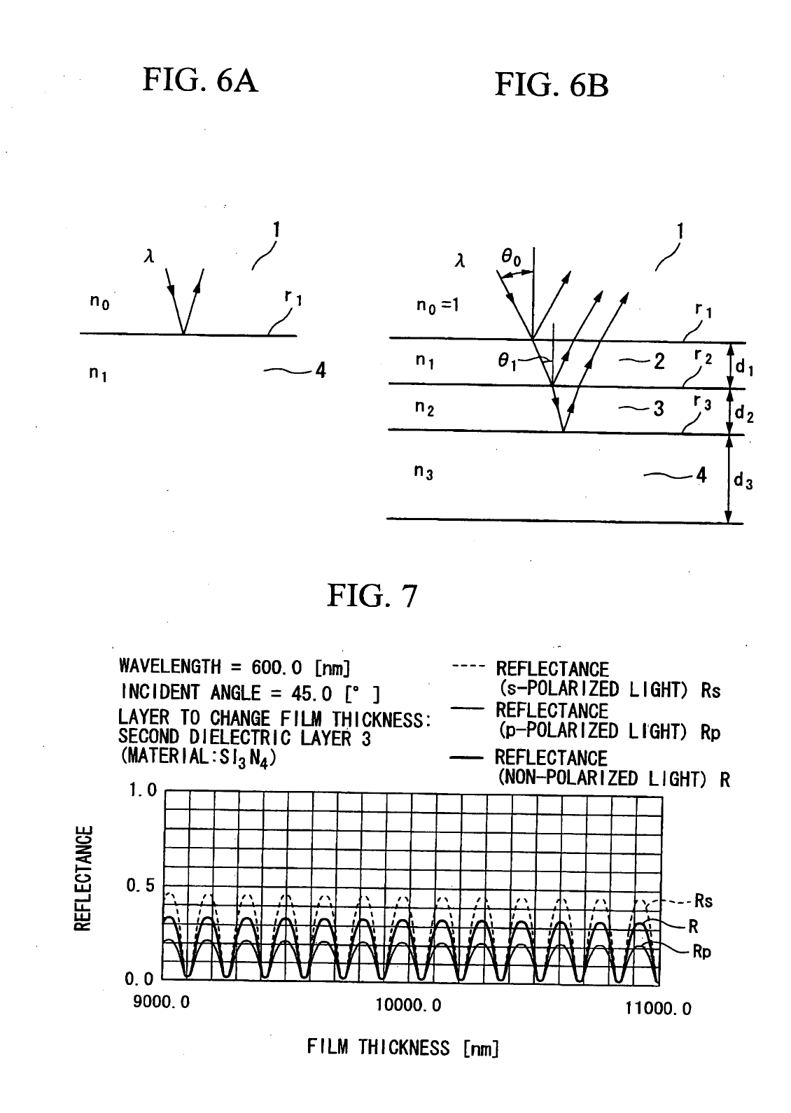

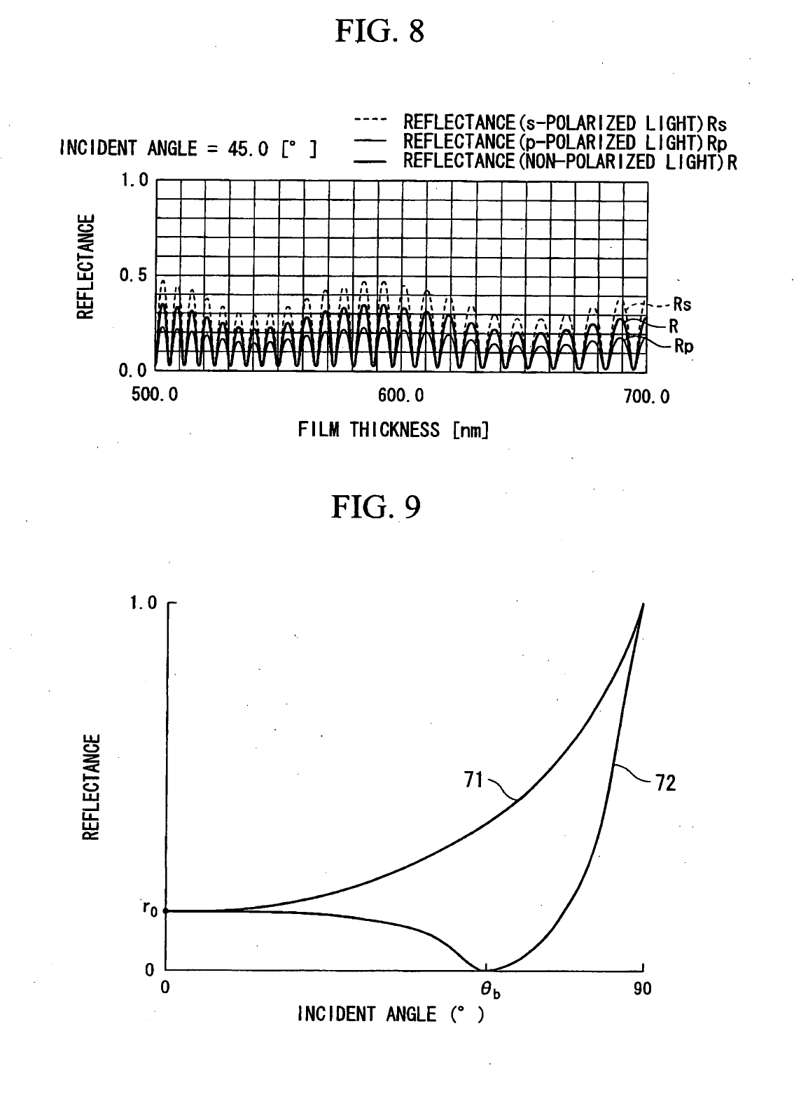

FIGS. 6A, 6B are schematic views in the cross sectional direction of the multi-layer film to show the reflectance of the multi-layer film. FIG. 7 is a graph showing an example of a numerical calculation to show the change in reflectance due to the thickness of the multi-layer film. The horizontal axis shows a changed film thickness and the vertical axis shows a reflectance. FIG. 8 is a graph to explain the reflection characteristics relative to the white light when the lower layers of the multi-layer film are made constant. The horizontal axis shows a wavelength (in nano meters). The vertical axis shows a reflectance of a multi-layer film.

As shown in FIG. 6A, when a light with wavelength λ enters a first dielectric layer 2 with an refractive index n₁ placed in an air layer 1 with an refractive index n₀, the reflection coefficient r₁ of the surface of the first dielectric layer 2 is expressed in the formula below by the formula of Fresnel.
r₁=(n₀−n₁)/(n₀+n₁) (1)

In the same way, as shown in FIG. 6B, a case in which a second dielectric layer 3 (refractive index n₂, thickness d₂) is formed of Si3N4, a first dielectric layer 2 (refractive index n₁, thickness d₁) formed of the photoresist are laminated in series and formed on the substrate 4 formed of silicon (refractive index n₃, thickness d₃) is considered, for example. In this case, by denoting each of the reflection coefficients of the surface of the first dielectric layer 2 which is in contact with the air layer 1, a boundary surface between the first dielectric layer 2 and the second dielectric layer 3, and the boundary surface between the second dielectric layer 3 and the substrate 4 as r₁, r₂, r₃, can be shown below. Here, n₀=1 is used.
r₁=(1−n₁)/(1+n₁) (1a)
r₂=(n₁−n₂)/(n₁+n₂) (2)
r₃=(n₂−n₃)/(n₂+n₃) (3)

By using these, the reflectance R₁₂ at the boundary surface between the first dielectric layer 2 and the second dielectric layer 3 is expressed below by the reflectance of Fresnel.

$${R}_{12} = \frac{{r}_{2} + {r}_{3} \cdot exp ( - ⅈ \cdot 2 {β}_{2} )}{1 + {r}_{2} \cdot {r}_{3} \cdot exp ( - ⅈ \cdot 2 {β}_{2} )} \qquad ( 4 )$$

Here, β₂ is as expressed below.
β₂=2π·(d₂/λ)·n₂·cos θ₁ (5)

Here, the angle θ₁ shows an incident angle of a light which enters the second dielectric layer 3 from the first dielectric layer 2 relative to the second dielectric layer 3.

And, a reflectance R₀₁ of the first dielectric layer 2 which is in contact with the air layer 1 is expressed as below formula in the same manner.

$${R}_{01} = \frac{{r}_{1} + {R}_{12} \cdot exp ( - ⅈ \cdot 2 {β}_{1} )}{1 + {r}_{1} \cdot {R}_{12} \cdot exp ( - ⅈ \cdot 2 {β}_{1} )} \qquad ( 6 )$$

Here, β₁ is expressed as below formula
β₁=2π·(d₁/λ)·n₁·cos θₒ (7)

Here, the angle θ₀ shows the incident angle of light which enters the first dielectric layer 2 from the air layer 1 relative to the first dielectric layer 2.

As it is understood from the formula (6), the reflectance R₀₁ of the surface of the first dielectric layer 2 is affected by both the film thickness d₁ of the first dielectric layer 2 and the film thickness d₂ of the second dielectric layer 3.

In FIG. 7, a specific numerical calculation example is shown. In the calculations of FIG. 7, as the first dielectric layer 2, the second dielectric layer 3, and the substrate 4, photoresist, Si₂N₄, and silicon were proposed to be employed and each of the values was made such that n₁=1.63, d₁=1000 nm, n₂=2.02, and n₃=3.947. Also, the wavelength of the incident light λ=600, incident angle θₒ=45° were used. When the film thickness d₂ of the second dielectric layer 3 is changed from 9000 nm to 11000 nm, the reflectance Rₛ of s-polarized light, the reflectance Rₚ of p-polarized light, and the reflectance R of non-polarized light were respectively plotted.

As shown in FIG. 7, the reflectances Rₛ, R, and Rₚ keep the relationship of Rₛ≧R≧Rₚ and in accordance with the change in the film thickness of the second dielectric layer 3 it is understood that they change sinusoidally in the same cycle. Therefore, even if the film thickness of the first dielectric layer 2 is even, the brightness of the reflected light of the illumination light fluctuates, which is influenced by the change in the film thickness of the second dielectric layer 3.

Also, when the light with wavelength λ is reflected to the multi-layer film, interference is generated in accordance with the difference in the light path between the light reflected from lower layer whereby light and dark pattern can be observed. For example, the film thickness is D, the angle in which the light advances in the thin film is φ, the refractive index of the film is n, and the following formula (8) shows a condition which lightens due to interference. The formula (9) shows a condition which darkens due to the interference.
D=λ·m·cos φ/(2·n) (8)
D=λ·(m+1)·cos φ/(2·n) (9)

Here, m=1, 2, 3, 4

Also, if the incident angle to the thin film is θ, there is the following relationship with the angle φ.
sin θ=n·sin φ (10)

In accordance with the formulas (8), (9), if the angle φ and the refractive index n are constant, it is understood that unevenness in the brightness is generated by the interference phenomenon of the reflected light due to the film thickness D and the wavelength λ.

FIG. 8 shows a calculation example of the reflected rate when d₂=10000 nm and the wavelength λ is changed from 500 n to 700 nm in the case of FIG. 6B. Other conditions are identical to those of FIG. 7.

As shown in FIG. 8, the reflectances Rₛ, R, and Rₚ keep the relationship of Rₛ≧R≧Rₚ and in relatively narrow band of wavelength and in relatively wide band of wavelength each of the reflectances substantially periodically change.

As described above, the reflected light of the multi-layer film generates unevenness in brightness as a result of interference generated in each of the wavelengths in accordance with the changes in film thickness in lower layer or wavelength distribution of the incident light.

That is, as shown in FIG. 7, as well as the reflected light lightens or darkens in accordance with changing amount in the film thickness of lower layer, light and dark are generated in wavelengths region as shown in FIG. 8.

Here, in FIG. 8, a case is proposed in that the light with wavelength of 500 nm to 700 nm is evenly irradiated. In this case, it is understood that since it is provided with a wavelength range of moderate periodic change of light and dark pattern for more than two rounds, averaged brightness can be obtained.

In formula (9), if the value of m has a wavelength range corresponding to a value which differs no less than 1 due to changes in the value of λ, a change in brightness, which is the same as the case when the film thickness D changes, is added whereby the incident light is detected as an average light quantity in which all the wavelengths are added.

This averaged brightness is consistently constant regardless of changes in the film thickness as the wavelength range is wide. Therefore, it is possible to control the above-mentioned influence of changes in the film thickness by entering a light with a wide wavelength range.

That is, it is expected to be averaged by including a wide range of wavelength lights which include at least one wavelength cycle that changes reflectance.

However, if optical white light is irradiated as an incident light which includes such a wide band of wavelengths, for example, the observer 49 has a luminous efficiency in which the peak of sensitivity is about 550 nm and it is not possible to average the unevenness in brightness visually, whereby an image which includes unevenness in brightness due to the interference can be observed. Therefore, such cases occur in that a region without defects is incorrectly recognized as a defect or unevenness in brightness becomes noise and reduces detection accuracy.

In the reference example, the illumination light 6b is corrected to a wavelength distribution which includes reverse characteristics to a wavelength distribution and spectral luminous efficiency of the illumination light 41. Whereby a light, in which the observer 49 can sense the intensity of the recognized light is substantially constant as shown in FIG. 5, contacts the tested object 40. Therefore, it is possible to average unevenness in brightness due to interference caused by the film thickness of lower layers or the wavelength of the incident light. Whereby, it is possible to make the quantity of the reflected light in the case of no defects substantially even as the average light quantity. That is, it is possible to perform observation or defect detection which is not influenced by the film thickness of lower layers.

Therefore, it is possible to prevent a region without defects from being incorrectly recognized as a defect or unevenness in brightness becoming noise and reducing detection accuracy.

Next, operations will be explained in which the polarization state is controlled.

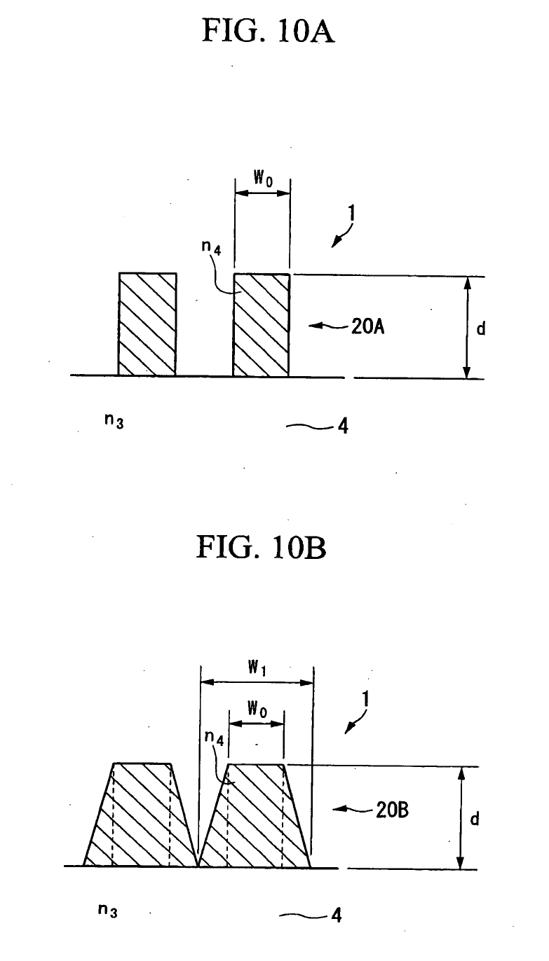

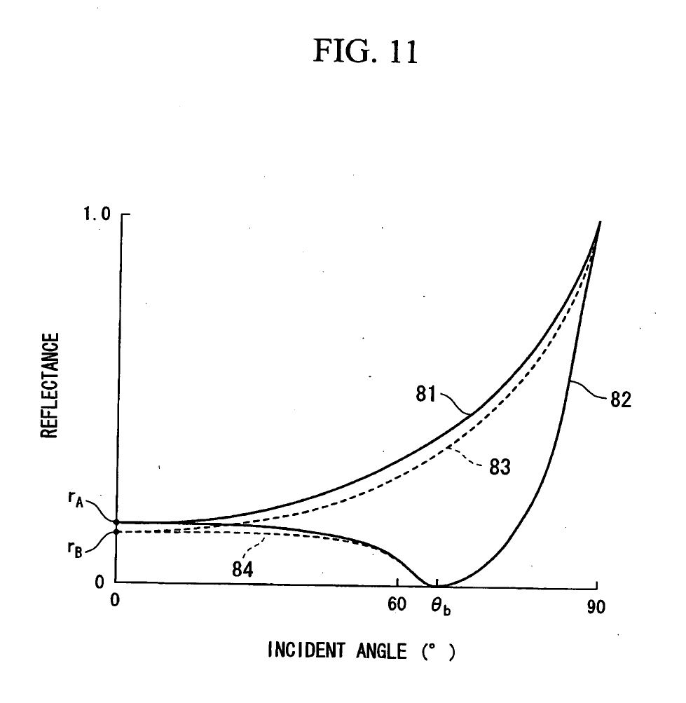

FIG. 9 is a graph to explain an incident angle dependency of the reflectance in accordance with a polarization state. FIG. 10A is a schematic sectional view in a layer thickness direction of a normal pattern and abnormal pattern formed on the top layer. FIG. 11 is a graph to explain the incident angle dependency of the reflectance when the multi-layer film has a refractive index distribution. In FIGS. 9 and 11, the horizontal axis shows an incident angle (in degrees). Also, the vertical axis shows a reflectance.

In general, the reflectance to light entering as an s-polarized light to a reflection surface, as shown with a curve 71 in FIG. 9, becomes r₀ (here 0<r₀<1) when the incident angle is 0°. As the incident angle increases from 0° to 90°, it simply increases with steeper slope and reaches 1 at an angle 90°. On the other hand, the reflectance with respect to light entering as a p-polarized light becomes, as shown with a curve 72 in FIG. 9, r₀ which is the same as the s-polarized light at incident angle 0°, and as the incident angle increases from 0° to θ_{b}, the reflectance simply decreases slightly with the negative slope increasing and the reflectance becomes 0 at the incident angle θ_{b}. The reflectance simply increases from 0 to 1 from the incident angle θ_{b} to 90°. The angle θ_{b} is called Brewster's angle or polarization angle. It is known that all of the p-polarized light component of light with its incident angle being the Brewster's angle becomes transmitted light relative to the reflection surface.

In this way, the light of p-polarized light has a tendency that it easily transmits the reflection surface in a wide range of incident angle range compared to the light of s-polarized light. Therefore, changes in reflection light due to abnormal shape in the surface layer or the like tends to become decreased compared to the light of s-polarized light. Due to this kind of characteristics, as shown in FIGS. 7, 8, there exists a relationship of Rs≧Rp even in a case with unevenness in brightness.

In the reference example, the illumination light 6b is set to become s-polarized light by the polarization plate 44A. With the s-polarized light, such an advantage can be obtained that it is possible to detect changes in reflectance sensitively as the reflectance increases compared to the case of p-polarized light or non-polarized light.

For example, as shown in FIG. 10A, a case is proposed in that a pattern in which a line and a space are periodically arranged (duty ratio 50%) with a pattern forming layer 20A (refractive index n4) provided with a width W₀ and film thickness d on the substrate 4 being formed with a pitch W₀. A disadvantage of the above case is that the width W₀ becomes thicker due to troubles of manufacturing apparatus or the like. For example, a case in which the width at the root is W1 (here, W₁>W₀) is proposed as shown in FIG. 10B.

This kind of defect can be detected as an abnormality in reflectance caused by an inclination in refractive index as this kind of defect can be regarded as a defect in which the refractive index is inclined to the thickness direction in a case where the film thickness d is close to the wavelength of the illumination light 6b.

For example, FIG. 11 shows the result of a simulation with regard to a dependency of the reflectance to the incident angle when n=1.3, W₀=45 mm, and the inclination rate of the refractive index is 4.5%, that is, (W₁−W₀)/d=0.045.

In FIG. 11, curves 81, 82 shown with solid lines show the inflection rate of the s-polarized light component or the p-polarized light component corresponding to a case for a pattern forming layer 20A without an inclination in the refractive index. Also, curves 83, 84 shown with dash lines show the inflection rate of the s-polarized light component or the p-polarized light component corresponding to a case for a pattern forming layer 20B with an inclination in the refractive index.

By comparing changes in each of the polarization components, the curves 81, 83 which show reflectance of the s-polarized light component show changes substantially identical to the curve 71 in FIG. 9 and the curves 82, 84 which show reflectance of the p-polarized light component show changes substantially identical to the curve 72 in FIG. 9. Reflectance r₀ at an incident angle of 0° in FIG. 9 corresponds to reflectances r_{A}, r_{B} in FIG. 11. The Brewster's angle θ_{b} is the median value between 60° and 70°.

On the other hand, whether there is inclination in the refractive index or not is compared, as it is understood from the curves 81, 83. In the s-polarized light component, at all the incident angles except 90°, the reflectance is decreased in a case in which there is a inclination in the inflection angle. In particular, the reflectance is steeply decreased in the vicinity of an incident angle of 60°.

Also, in the p-polarized light component, if there is an inclination in the refractive index, at incident angle 0° to 30°, the reflectance is decreased slightly. However, at incident angle of 50° or more, influence of the inclination in the refractive index is hardly seen.

Therefore, by illuminating with the s-polarized light at an incident angle of the illumination light 6b set to 60°, the reflectance of the s-polarized light is steeply decreased in a region with an inclination in the refractive index, whereby it is detected as a region which darkens. In this case, by switching to the p-polarized light by, for example, rotating the polarization plate 44A, it is possible to confirm that it is not a noise due to other unevenness in brightness since there are no changes in brightness relative to a normal region.

In this way, by controlling the polarization state, there is an advantage in being able to detect such defects that appear as the inclination in the refractive index with high accuracy.

This kind of the inclination in the refractive index is also formed by an inclination in the lateral surface of the above-mentioned pattern. However, even in the case in which there is no inclination in the lateral surface, the inclination in the refractive index is formed when the thickness in the pattern forming layer 20A fluctuates depending on the portion, whereby it is detected as well in the case of such defects existing.

Here, there is a case in which the reflected light 7 becomes elliptical polarization light depending on the multi-layer film of the tested object 40. In this case, by arbitrary rotating the polarization plate 44B, it is possible to observe only the s-polarized light component, whereby it is possible to detect defects by using the reflection characteristics of the above-mentioned s-polarized light component.

Also, it is possible to easily detect defects which change the polarization state, by using the polarization plate 44A in combination with the polarization plate 44B.

That is, by rotating around the light axis by the polarization plate movement mechanism 48, it is possible to detect defects such as scratches, foreign materials, and abnormal crystals which make reflected light 7 a scattering light by selectively picking up lights in various polarization states from the reflected light 7.

By placing the polarization plates 44A, 44B in the crossed nicols state to make the reflected light from the normal portion a quenching state, it is possible to detect more effectively since only the abnormal portion in the polarization state shines in the dark field.

In this way, the surface defect inspection apparatus 500 of the reference example viewed visually is provided with a wavelength distribution, in which the light intensity is substantially sensed even under the spectral luminous efficiency characteristics, as the illumination light 6b. Therefore, in a case of inspecting the tested object in which the multi-layer film is formed, it is possible to improve the inspection accuracy as unevenness in brightness or unevenness in color doesn't easily occur even if there is a difference in the film thickness in the lower layers.

In this prevention method of defect inspection accuracy degradation by visual observation on the reference example, it is possible to apply a surface defect inspection apparatus using an image capturing apparatus such as a CCD camera.

### FIRST EMBODIMENT

A surface defect inspection apparatus in accordance with a first embodiment of the present invention will be explained.

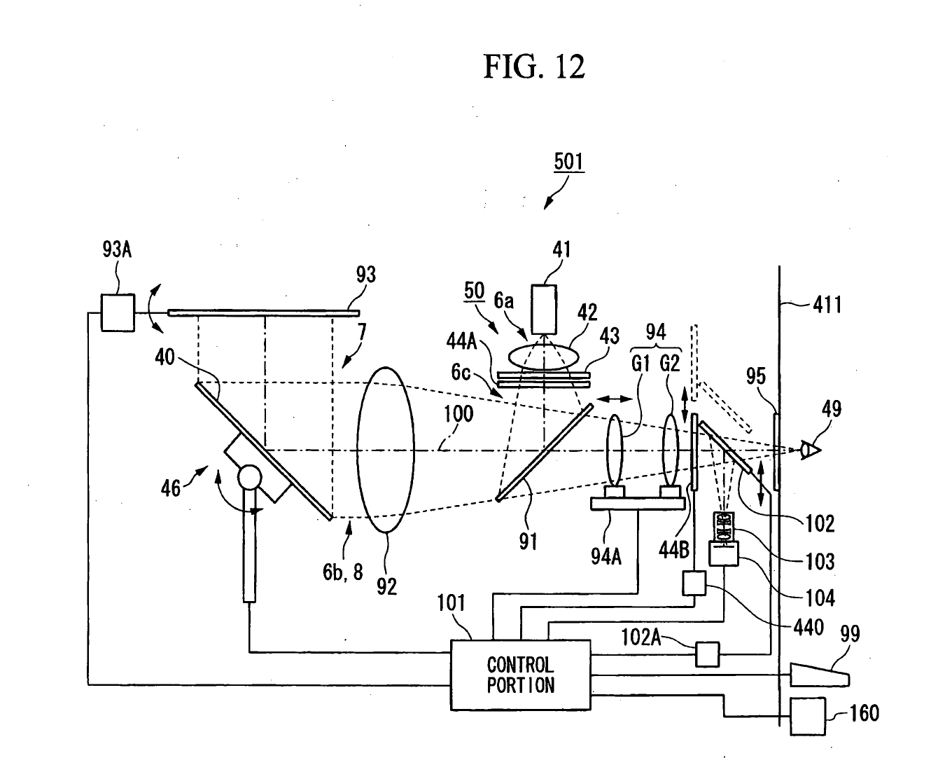

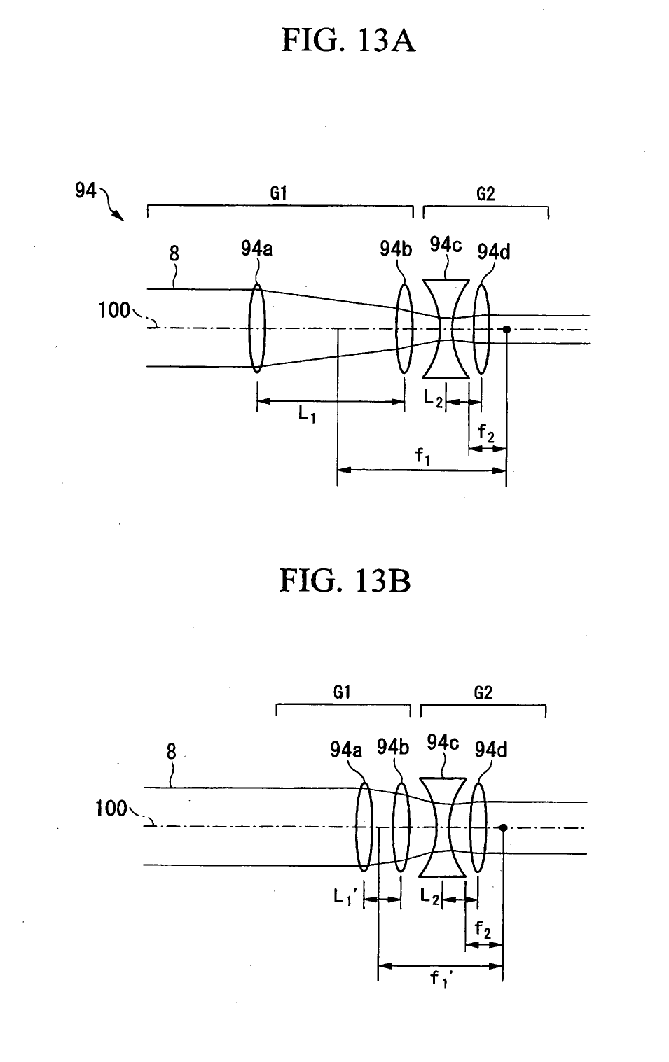

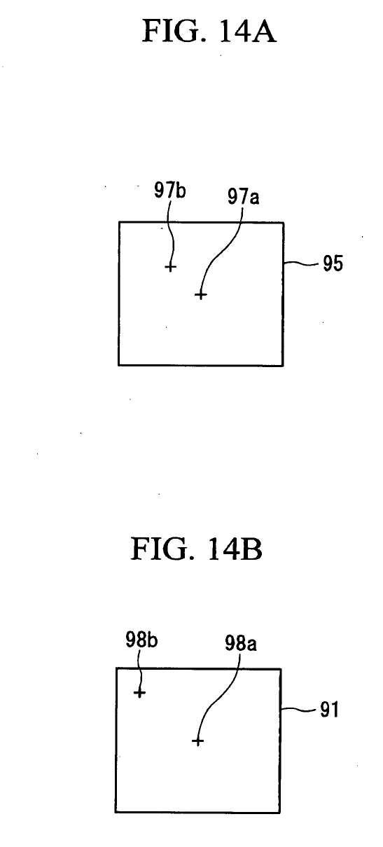

FIG. 12 is a schematic front view of the general construction of the surface defect inspection apparatus of the first embodiment of the present invention. FIG. 13A is a light path diagram shown in a schematic view to explain one example of the lens constitutions of the projection correction lens used for the surface defect inspection apparatus of the first embodiment of the present invention. FIG. 13B is a light path diagram shown in a schematic view to explain movement of projection correction lens as well. FIGS. 14A, 14B are explanatory diagrams viewed from a normal line direction to explain the front glass and reticle mark of a half mirror used for the surface defect inspection apparatus of the first embodiment of the present invention.

The surface defect inspection apparatus 501 of the present embodiment is, as shown in FIG. 12, an apparatus to inspect surface defects of the tested object 40 by visually observing or image capturing the re-reflected light 8 made by irradiating the illumination light 6b on the tested object 40 and re-directing its reflected light 7 onto the tested object 40.

The general construction of the surface defect inspection apparatus 501 includes an illumination portion 50, a half mirror 91, a collimating lens 92 (illumination optical system), a rotating mechanism 46, a mirror 93 (reflection element), a projection correction lens 94 (an optical element which contracts image of the tested object only in one direction), a polarization plate 44B, a mirror 102 (light path switching portion), a group of image formation lens 103, an image capturing element 104 (image capturing portion), and control portion 101 in which all of the components are covered by a partition wall portion 411, a part of which is provided with a front glass 95 (translucent screen).

The illumination portion 50 has a constitution in which the collimating lens 45 is deleted from the illumination portion 5 of the reference example. That is, it is formed with the illumination lamp 41, condensing lens 42, compensation filter 43, and polarization plate 44A. The illumination light 6a irradiated from the illumination lamp 41 is condensed by the condensing lens 42 and then the illumination light 6c in which the degree of divergence is slightly decreased is irradiated.

The half mirror 91 reflects substantially 50% of the illumination light 6c, bends the light path of the illumination light 6c, and is a light path branch portion which transmits re-reflected light 8 re-reflected by the tested object 40. Therefore, it functions as a translucent screen relative to the re-reflected light 8. As shown in FIG. 14B, reticle marks 98a, 98b (reference pattern) are provided to facilitate the alignment of the observation position when visually viewed. The reticle marks 98a, 98b can be placed with an arbitrary shape and in an arbitrary position. For example, as a reticle mark 98a, a crossing mark can be employed which is placed substantially in the center of the half mirror 91 so as to align with the light axis of the incident light and a crossing mark which is placed in periphery portion as a reticle mark 98b can be employed.

The collimating lens 92 forms the illumination 6b by turning the illumination light 6c reflected by the half mirror 91 into parallel light.

The rotating mechanism 46 rotatably retains the tested object 40 at a position which can be irradiated by the illumination light 6b the same as in the reference example.

The mirror 93, as a re-entry optical system, is a reflection element which is placed in a position in which the reflected light 7 reflected by the tested object 40 enters from a normal line direction.

The rotating mechanism 46, the mirror 93 are formed such that an angle attitude relative to the light path of the illumination light 6b and the reflected light 7 can be controlled by a control portion 101 described later.

The projection correction lens 94 is a group of lenses, which are used when observing the re-reflected light 8 in which the reflected light 7 reflected by the mirror 93 is reflected by the tested object 40, to correct deformation caused by the reflected light 7 being reflected to a diagonal direction of the tested object 40. The projection correction lens 94 is placed on the light path after transmitting through the collimating lens 92 and the half mirror lens 91.

As the specific constitution of the projection correction lens 94, a group of cylindrical lenses which have the power to focus a light flux in the up-and-down direction shown in the drawing can be employed. For example, as shown in FIG. 13A, from the order of incident direction of the re-reflected light 8, a first lens group G1 constituted by a first lens 94a having a convex cross section and a second lens 94b having a convex cross section, and a second lens group G2 constituted by a third lens 93c having a concave cross section and a fourth lens 94d having a convex cross section are placed so that the focus position of the first lens group G1 and the focus position of the first lens group G2 are aligned. By the movement mechanism 94A, with a front side of the focus position of the first lens group G1 being kept in a fixed position, the first lens 94a and the second lens 94b are arranged so as to be movable in the light axis direction. The movement mechanism 94A is electrically connected to the control portion 101.

The second lens group G2 is formed so that the distance between the third lens 94c and the fourth lens 94d is L₂ and the composite focus distance is f₂.

The first lens group G1 is formed so that the inter-lens distance between the first lens 94a and the second lens 94b is variable. For example, when the distance is L1 then the composite focus distance is f1 (here, it includes values of f1>f2). Also, as shown in FIG. 13B, when a distance between the lenses is L₁′, the front side composite focus distance is f₁′.

The composite focus distance f₁ can be expressed as below when the focus distances of the first lens 94a and the second lens 94b are fₐ and f_{b} respectively.
1/f₁=1/fₐ+1/f_{b}−L1/(fₐ·f_{b}) (11)

Here, instead of f₁ and L₁, f₁′ and L₁′ also satisfy formula (11).

That is, by moving the first lens 94a and the second lens 94b to make the inter-lens distance L1′ (here, L₁′<L₁), then f₁′<f₁. The positions of the first lens 94a and the second lens 94b are adjusted to align the position of the f₁′ with the composite focus position of the second lens group G2. As a result of this, the light flux width in the up-and-down direction shown in the drawing is changed in accordance with changes in the focus distance f₁′. For example, if the incident light is an elliptical light flux having its major axis in the up-and-down direction shown in the drawing, by adjusting the focus distance of the first lens group G1 to an arbitrary value, it is possible to irradiate an outgoing light as a circular light flux.

On the image side of the light path of the projection correction lens 94, the polarization plate 44B is provided so as to be movable in a forward and backward direction.

The mirror 102 is a reflection element to guide a light path which is irradiated from the projection correction lens 94 and transmits the polarization plate 44B if necessary for the group of image formation lenses 103 by switching the light path. The mirror 102 is provided so as to be movable in a forward and backward direction relative to the light path by the movement mechanism 102A or detachable if necessary.

The front glass 95 has a constitution substantially identical to the front glass 47 of the reference example. Here, in this embodiment, it is provided with reticle marks 97a, 97b (reference pattern) with which the observer 49 can align the observing position while observing visually.

The reticle marks 97a, 97b are placed as crossing marks or the like in, for example, the center of the front glass 95 and peripheral portion corresponding to the reticle mark 98a, 98b of the half mirror 91 respectively (refer FIG. 14A).

That is, the reticle mark 97a placed in the center portion is placed on the light axis and the reticle mark 97b placed in the peripheral portion is placed in a positional relationship identical to an image of the reticle mark 98b placed in the peripheral portion as well when observed from an image formation position on the light axis.

The group of image formation lenses 103 is to form an image on the surface of the tested object 40 on the image capturing surface of the image capturing element 104 by the light flux reflected when the mirror 102 extends in the light path. Although the tested object 40 is inclined due to the swing movement, an aperture stop may be placed in the group of image formation lenses to sufficiently deepen the depth of field. Also, a focusing function may be provided to focus a desired position.

The image capturing element 104 is formed of an image capturing element such as CCD, which images two-dimensional images, and takes images of tested object 40 and obtain image data.

The control portion 101 performs the control of the entire surface defect inspection apparatus 501 or image processing control in accordance with the observer 49's operational input via a operation portion 99.

That is, the control portion 101 is electrically connected to the mirror 93, the projection correction lens 94, movement mechanisms 93A, 94A, and 440 of the polarization plate 44B, and the rotating mechanism 46. The control portion 101 is able to transmit control signals which make the above components move.

Also, the control portion 101 is electrically connected to the image capturing element 104 and can obtain image data and perform image processing such as displaying or extracting defect images as disclosed in Japanese Unexamined Patent Application, First Publication No. 2001-91473 or the like.

Next, a movement of the surface defect inspection apparatus 501 of the present invention will be explained.

As shown in FIG. 12, from the illumination portion 50, the illumination light 6c, which is identical to the reference example except that the irradiating light is a scattering light, is irradiated toward the half mirror 91. That is the illumination light 6c is corrected so that the light intensity is observed to be substantially even when the observer 49 having a spectral luminous efficiency characteristic performs visual observation. Also, the polarization state is set to become the s-polarized light relative to the tested object 40.

Also almost 50% of the illumination light 6c is reflected by the half mirror 91, it is deflected along the light axis of the collimating lens 92. Also, it is irradiated substantially in one direction onto the tested object 40 as the illumination light 6b which is made substantially parallel light flux by the collimating lens 92.

The illumination light 6b irradiated to the tested object 40 is reflected by the tested object 40 and is directed to the mirror 93 as a reflected light 7. Here, the brightness of the reflected light 7 is determined by the reflectance shown in formula (6).

Also, depending on the surface state of the tested object 40, the polarization state changes.

The position of the mirror 93 is controlled by the control portion 101 so that the reflected light 7 enters from a normal line direction. Whereby the reflected light 7 directed mirror 93 is reflected by the mirror 93, reversely advances the light path, is re-directed to the tested object 40 and is reflected toward the collimating lens 92 as the re-reflected light 8.

The brightness I₈ of the re-reflected light 8 is expressed below where the brightness of the illumination light 6b is I_{6b} and the reflectance of the mirror 93 is Rₘ.
I₈=(R₀₁)²·Rₘ (12)

That is, the light is reflected by the tested object 40 twice, and significant changes in brightness are shown in which influence of the changes in film thickness or inclination in the refractive index of the multi-layer film reflection is raised to the second power. Here, only the unevenness in brightness due to the change in inclination in the refractive index is significantly shown since unevenness in brightness in accordance with the film thickness cancel each other as it is regarded as white light to the observer 49 by the operation of the compensation filter 43.

Therefore, it is advantageous in that a detection sensitivity of the inclination in the refractive index can be improved compared to the reference example.

The re-reflected light 8 becomes a convergent light after transmitting through the collimating lens 92 and transmits through the half mirror 91. Also, the diameter of the light flux in the up-and-down direction in the drawing is adjusted by the projection correction lens 94. For example the deformation in the image is corrected to a shape without deformation viewed from an observation direction identical to a case in which the tested object 40 is planarly viewed, that is, in the case of the present embodiment, the outer shape of the image is corrected to a circular shape and the light is irradiated.

When the polarization plate 44B is extended to the light path, and when the mirror 102 is away from the light path, only the predetermined polarization component transmits due to the polarization plate 44B and forms a light path which is irradiated to the outside of the partition wall portion 411 through the front glass 95. Therefore, the observer can visually view the image of the tested object 40 by way of the re-reflected light 8.

In this case, since reticle marks 97a, 97b, 98a, and 98b are provided to the half mirror 91 and the front glass 95, the observer 49 may move the observation position perpendicular to the light axis direction to align the reticles marks 97a, 98a observed substantially in the center of the field of view. Furthermore, by moving the observation position to the light axis direction to align the reticle marks of periphery portions 97b, 98b, it is possible to visually observe at the image formation position of the re-reflected light 8.

Also, the observer 49 may operate from the operation portion 99 according to necessity, activate the rotating mechanism 46 by the control portion 101, and rotatably move the tested object 40. Whereby the operator 49 can arrange the tested object 40 to easily view defects.

In this case, the control portion 101 controls the attitude of the mirror 93 in accordance with the swing position of the rotating mechanism 46 and retains the incident direction of the reflected light 7. Also, the control portion 101 performs control by changing the focus distance of the projection correction lens 94 in accordance with the swing position of the rotating mechanism 46 so that the diameter of the light flux becomes substantially constant. Therefore, even when the tested object 40 is moved to a swing position in which the defect is easily viewed, the observer 49 can observe in the same state as planarly viewing the tested object 40, whereby it is advantageous in that detection of the defect position becomes easy.

On the other hand, when the polarization plate 44B is extended to the light path and the mirror 102 is extended to the light path, only the predetermined polarization component transmits due to the polarization plate 44B. Then, the predetermined polarization component is deflected at the mirror 102 and is directed to the group of image formation lenses 103 and the light path, through which the re-reflected light is image captured by the image capturing element 104, is formed. Therefore, the image of the tested object 40 is image captured, photoelectric-converted, and obtained as image data by the control portion 101. Here, when the wavelength (dispersion) sensitivity characteristics of the image capturing element 104 are different from the luminous efficiency characteristics of the human eye, the compensation filter 43 needs to be set in such a way that the output intensity of the image capturing element 104 becomes substantially constant along the wavelengths to which sensitivity is provided. Therefore, it is preferable that when the mirror 102 extends to the light path, the compensation filter 43 is switched.

In the control portion 101, it is possible to perform arbitrary defect detection operations by using images identical to visually viewed images or it is possible to display the image itself or images which are image processed to a monitor 160 or the like.

In this manner, with this embodiment, by extending and retracting the mirror 102 to and from the light path to switch the light path, it is possible to perform visual observation or to image capture by the re-reflected light 8 which was made by illumination light 6b being reflected from the tested object 40 twice. Here, the illumination light 6b is a light in which the light intensity the observer 49 senses as substantially constant regardless of the wavelength or the output intensity of the image signal from the image capturing element as substantially constant regardless of the wavelength.

Here, the operations of the polarization plate 44A, 44B of this embodiment are identical to those of the reference example.

Also, in both cases of visual observation or image capturing, when there is no need to control polarization components for the purpose of defect detection or the like, the polarization plate 44B may be moved away from the light path of the re-reflected light 8 by the control portion 101 so that the re-reflected light 8 does not transmit through the polarization plate 44B.

In this manner, in accordance with the surface defect inspection apparatus 501, it is possible to eliminate the influence of changes in the film thickness by making the light intensity of the illumination light 6b to be sensed as substantially constant regardless of the wavelength to the observer 49 or image capturing element 104. Whereby, it is possible to improve the detection accuracy of defects with inclination in the refractive index since it is possible to observe the re-reflected light 8 which is reflected by the tested object 40 twice. That is, if the mirror 93 of the re-incident light system is only introduced, noise components due to the influence of the changes in film thickness or the like is emphasized simultaneously. However, after reducing the noise component and introducing the mirror 93, it is possible to perform defect detection with a higher accuracy.

Also, by the projection correction lens 94, it is possible to always observe the tested object 40 in a state without deformation. Whereby, it facilitates the observation of defects or to identify the defect positions and it improves detection accuracy and at the same time, it is possible to improve the efficiency of the defect inspection as the inspection time can be reduced.

Next, a first modification of the present invention will be explained

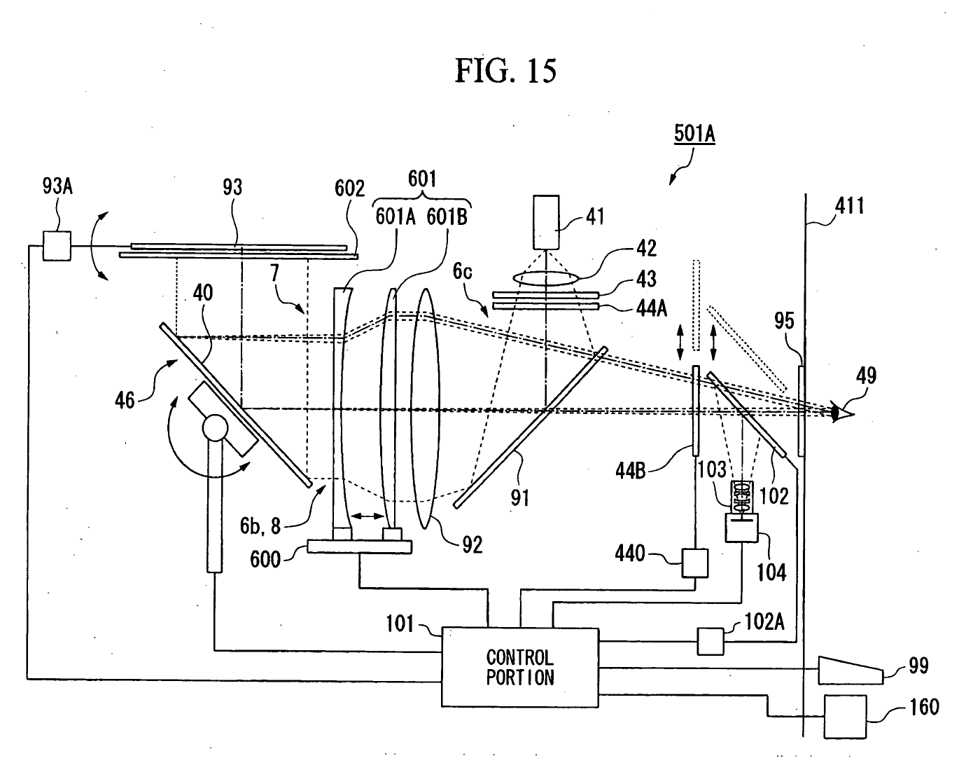

FIG. 15 is a front view showing a schematic view of the general construction of the surface defect inspection apparatus in accordance with the first modification example of the first embodiment of the present invention.

The surface defect inspection apparatus 501A of the present modification example, as shown in FIG. 15, is formed by deleting a projection correction lens 94 of the above-mentioned first embodiment and by adding a projection correction lens 601 (an optical element which extends and retracts the image of the tested object only in one direction) and electric-powered scattering plate 602. Hereinafter, only differences from the above-mentioned first embodiment will be explained.

The projection correction lens 601 is the same as the projection correction lens 94 a group of lenses which correct deformation caused by the re-reflected light 8 reflected in the diagonal direction relative to the tested object 40 when observing the re-reflected light 8 reflected by the tested object 40 by which the reflected light 7 reflected by the mirror 93 is reflected. The projection correction lens 601 is provided on the light path between the tested object 40 and the collimating lens 92.

As the constitution of the projection correction lens 601, a first correction lens 601A and a second correction lens 601B, which are a group of cylindrical lenses with a power that converges light flux to a direction identical to the swing direction of the rotating mechanism 46, for example, the up-and-down direction in the drawing, are provided in series from the side of the tested object 40. Whereby, it is possible to employ a constitution in which the projection correction lens 601 is movable in the light axis direction by the projection correction lens movement portion 600.

In the embodiment of the present modification example, the first correction lens 601A is formed of a cylindrical lens of a flat concave cross section and the second correction lens 601B is formed of a cylindrical lens of convex flat cross section. The respective concave surface and convex surface have an identical curvature of radius. Therefore, in a state in which these concave and convex surfaces are respectively attached, a flat plate is formed and the power of each of the lenses is canceled. Also, in a state in which each of the lens are moved away and air intervals are formed, a parallel light flux from the tested object 40 is amplified to the up-and-down direction.

The electric-powered scattering plate 602 is a mechanism which becomes a scattering plate or transmitting plate in accordance with the incoming voltage. For example, it is formed of liquid crystal scatterplate or the like. Together with the mirror 93, the electric-powered scattering plate 602 is formed to be rotatable by the movement mechanism 93A in accordance with the changes in the swing angle of the rotating mechanism 46.

Here, it is preferable that the electric-powered scattering plate 602 is constituted to be able to form a light shielding state as well by using the liquid crystal polarization plate.

In accordance with the surface defect inspection apparatus 501A of the present modification example, when the swing angle of the rotating mechanism 46 is detected by the control portion 101, the projection correction lens movement portion 600 is driven corresponding to the swing angle. Whereby, an inter-lens distance between the first correction lens 601A and the second correction lens 601B is controlled. That is, the light flux of the up-and-down direction in the drawing which follows the swing direction is amplified and Therefore the deformation of the tested object 40 is corrected. Therefore, it is possible to observe the tested object 40 as if the tested object 40 were provided in parallel and in front of the observer 49.

At this time, as the projection correction lens 601 is placed in the light path between the collimating lens 92 and the tested object 40, even if the swing angle is changed, it is possible to illuminate the tested object 40 effectively by changing the width of the illumination light 6b which is irradiated onto the tested object 40. Therefore, it is possible to stabilize the inspection accuracy as it is possible to observe under substantially the same brightness condition.

Also, by placing the electric-powered scattering plate 602, it is possible to easily change the level of scattering of the reflected light 7 of the mirror 93. Therefore, it is possible to perform observation in a state in which the level of deleting the unevenness in brightness is changed in accordance with the changes in film thickness.

Here, if there is no need to perform that kind of observation, the electric-powered scattering plate 602 may be deleted.

### SECOND EMBODIMENT

A surface defect inspection apparatus in accordance with a second embodiment of the present invention will be explained.

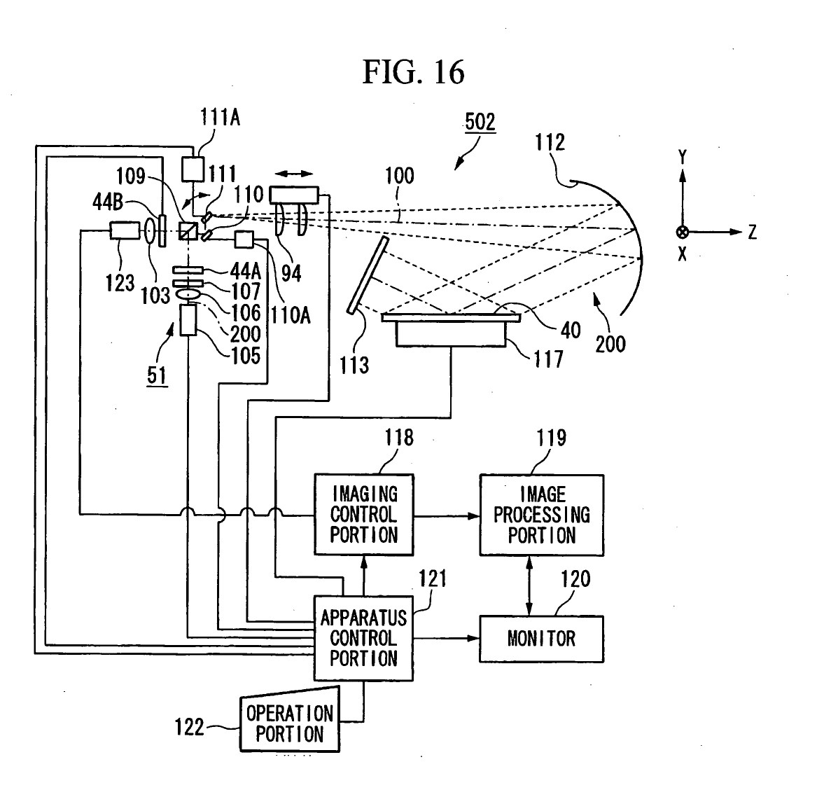

FIG. 16 is a schematic front view of the general construction of the surface defect inspection apparatus of the second embodiment of the present invention. An XYZ polar coordinate system is shown in the drawing for reference directions. The system is constituted by the X axis being defined from front to back along the normal direction relative to the drawing, the Z axis being defined from left to right, and the Y axis being defined from top to bottom.

A surface defect inspection apparatus 502 of the present embodiment is, as shown in FIG. 12, an apparatus to inspect surface defects of the tested object 40 by image capturing the re-reflected light 8 which was made by scanning the tested object 40 by a laser beam light source and re-directing its reflected light to the tested object 40.

The general construction of the surface defect inspection apparatus 502 includes an illumination portion 51, a polarization plate 44A, a beam splitter 109, deflection mirrors 110, 111, the projection correction lens 94, a field mirror 112, a mirror 113 (reflection element), the polarization plate 44B, the group of image formation lenses 103, a light detection element 123 (image capturing portion), an apparatus control portion 121, an image capturing control portion 118, an image processing portion 119, a monitor 120, and an operation portion 120.

The illumination portion 51 includes a laser light-emitting diode 105 (light source) composed of a plurality of laser light sources which can generate a laser light 200 (illumination light) of a plurality of wavelengths, a collimating lens 106 which converts a laser light irradiated from the laser emitting diode 105 to a small diameter parallel beam compared to the area of the tested object 40, and a wavelength compensation plate 107 (wavelength sensitivity correction filter).

The plurality of wavelengths of the laser light-emitting diode 105 is set in a band of wavelengths in which when they are combined by a combiner or the like, an intensity distribution of the white light or close to the white light is formed. For example, by placing a laser emitting diode of a number of different wavelengths, it may be formed as a laser light with a plurality of wavelengths scattering along all the optical wavelengths. Also, compared to an inspection with a single color, with two or three wavelengths, inaccordance with conditions, it is possible to eliminate influence of the unevenness in the film of the lower layer. Whereby, for example, a plurality of laser lights respectively including wavelength lights closer to the center band of R, G, B wavelengths which are the three primary colors of light.

The wavelength compensation plate 107 is an optical member in which the intensity distributions of each of the plurality of wavelengths of laser light irradiated from the laser emitting diode 105 and transmitting the collimating lens 106 are made so as to be image captured as substantially white light by decompensating the intensity distribution by the wavelength sensitivity characteristics of the light detection element 123.

The compensation characteristics of the wavelength compensation plate 107 can be set in substantially the same manner as the compensation filter 43 of the reference example. However, the wavelength compensation plate 107 is different from the compensation filter 43 in that the wavelength band to be corrected is a plurality of homogeneous lights or narrow-band lights and the wavelength characteristics to be decompensated are the wavelength sensitivity characteristics of the light detection element 123.

The wavelength compensation plate 107 can be formed as an optical filter constructed with necessary compensation characteristics by the multi-layer film coating. Also, since the compensation characteristics are required to set only to a plurality of wavelengths included in the laser light 200, a plurality of filters which adjust intensity of each of the wavelength lights may be used in combination.

The beam splitter 109 is a light path branch portion which reflects the laser light 200 transmitted through the polarization plate 44A to the deflection mirror 110 placed in the Z axis positive direction in the drawing, for example, and guides it to the polarization plate 44B by transmitting the laser light reflected by the deflection mirror 110 to the Z axis negative direction in the drawing to be returned.

The deflection mirrors 110, 111 are movably retained by the reversing mechanisms 110A, 111A which are controlled by the apparatus control portion 121. Whereby the deflection mirrors 110, 111 are beam scanning mechanisms which perform two-dimensional scanning on the incident beam by turning themselves in two mutually exclusive axis directions.

The deflection mirror 110 is made so as to be able to defectively scan the laser light 200 reflected by the beam splitter 109 within the XY plane in the drawing, with the Y axis positive direction as the center, and within the predetermined scanning angle of view range.

The deflection mirror 111 is made so as to be able to defectively scan the laser light 200 deflectively scanned by the deflection mirror 110 within a plane perpendicular to the ZX plane in the drawing, with a direction along the ZX plane as the center, and within the predetermined scanning angle of view range.

As the deflection mirrors 110, 111, deflective scanning elements such as Galvano-Mirror may be employed.

The laser light 200 deflectively scanned by the deflection mirror 111 is directed to the field mirror 112 transmitting the projection correction lens 94.

The field mirror 112 is a reflection element which reflects the laser light 200 two-dimensionally scanned by the deflection mirrors 110, 111 and makes it direct to a predetermined angle relative to the tested object 40 as an incident light optical system. That is, even defectively scanned in any direction by the deflection mirrors 110, 111, any of the light fluxs are in parallel relative to the tested object 40. As a curved shape surface of the reflection surface of the field mirror 112, a paraboloidal or an aberration-corrected free-form surface such as an astigmatism corrected free-form surface may be employed.

Here, the dashed line in FIG. 15 is a line to show the range deflected by the deflection mirrors 110, 111.

The specimen support 117 is a retaining mechanism to retain the tested object 40 with a predetermined angle relative to the irradiating direction of the reflected light of the field mirror 112. The specimen support 117 is preferably provided with an arbitrary movement mechanism to adjust the arranged position of the tested object 40 relative to the field mirror 112 following the control signal of the apparatus control portion 121.

The mirror 113 is a flat mirror arranged so that the specular reflection direction of the laser light 200 reflected by the tested object 40 becomes a normal line direction.

The group of image formation lenses 103 is an image formation element which is provided opposite to the deflection mirror 110 positioning the beam splitter 109 therebetween. The group of image formation lenses 103 forms an image from a light transmitted through the beam splitter 109 among the laser light 200 reflected by the deflection mirror 110 on an acceptance surface of the light detection element 123.

The light detection element 123 performs photoelectric conversion by receiving the laser light 200 on the image formation surface by the group of image formation lenses 103. A photodiode or a electron multiplier may be employed as the light detection element 123.

The polarization plate 44B is provided between the beam splitter 109 and the group of image formation lenses 103 to control the polarization state of the laser light 200.

The apparatus control portion 121 performs the entire control of the surface defect inspection apparatus 502 and it is operated by the operation portion 122, and is electrically connected to the movement mechanism 440 which moves the laser emitting diode 105 and the polarization plate 44B, the movement mechanism 94A which moves deflection mirrors 110, 111, and the projection correction lens 94, and the specimen support 117 or the like to transmit suitable control signals.

Relative to the movement mechanism 440, the apparatus control portion 121 transmits control signals to make the polarization plate 44B extend and retract into the light path.

Relative to the deflection mirrors 110, 111, the apparatus control portion 121 transmits control signals to deflectively scan a predetermined position on the tested object 40 by the laser light 200.

Relative to the movement mechanism 94A, the apparatus control portion 121 transmits control signals to adjust inter-lens intervals to obtain the image of the tested object 40 without deformation.

Relative to the specimen support 117, the apparatus control portion 121 transmits control signals to adjust the position of the tested object 40.

The image capturing control portion 118 transmits control signals to perform image capturing operations to obtain image data of each of the scanning positions in accordance with the control signals relative to the scanning positions of the deflection mirrors 110, 111 by the apparatus control portion. The image capturing control portion 118 obtains image data and transmits image data to the image processing portion 119 together with the date on the scanning positions.

The image processing portion 119 is an apparatus that stores image data transmitted from the imaging control portion 118, extracts abnormal unevenness in brightness by image processing, and determines position, size, category or the like of defects. Algorithms for image processing and defects extractions may be employed to any widely known apparatuses used for surface inspection.

For example, based on correction data preliminarily stored in accordance with the tested object 40, the image processing portion 119 performs the following image corrections, namely a shading correction which corrects, unevenness in brightness caused in accordance with characteristics of optical systems in the surface defect inspection apparatus 502 or the light detection element 123 for each of the pixels of the image data, a distortion correction which eliminates image distortion by the optical system based on the correction data, and a position error correction which corrects displacement of image data by detecting information on displacement of the tested object 40. The image processing portion 119 extracts defect information from the tested object 40 by performing a comparison processing between the image data after correction and the image of the good product preliminarily stored. Also, if needed, defects may be extracted by comparing the image data of the tested object 40 to constructed data in which an image of a good product is constructed by segmentalizing the image data of the tested object 40 and determining portions included in a large number as the good product.

Extracted defects are categorized in order to identify the process in which the defect was generated and the cause of the defect so as to identify the category of the defect by comparing with information stored in a defect database.

The monitor 120 is a display portion to display images processed by the image processing portion 119, images of defects, and operation menu display to be operationally input by the operation portion 122.

Next, movement of the surface defect inspection apparatus 502 will be explained.

The laser light 200 generated by the laser emitting diode 105 is made into a parallel beam by the collimating lens 106, and is adjusted to a distribution by the wavelength compensation plate 107 such that the wavelength distribution of a plurality of wavelengths is received as having substantially constant light intensity in accordance with the wavelength sensitivity characteristics of the light detection element 123.

Further, by the polarization plate 44A, a polarization state is controlled to be the s-polarized light relative to the tested object 40 and the laser light 200 enters the beam splitter 109 in the positive Y axis direction side in the drawing.

The laser light 200 having been directed to the beam splitter 109 is reflected by the beam splitter 109 and is directed to the deflection mirror 110 and is deflectively scanned within the XY plane in the drawing. This corresponds, on the tested object 40 provided in the ZX plane, to a beam scanning in X axis direction in the drawing.

The laser light 200 deflectively scanned by the deflection mirror 110 is deflectively scanned within a plane perpendicular to the ZX plane by the deflection mirror 111. On the tested object 40, this corresponds to a beam scanning in the Z axis direction in the drawing.

Deflectively scanning by the deflection mirrors 110, 111 is performed periodically, but in the following explanations, the laser light 200 is scanned in one of the directions. That is, the laser light 200 is reflected from the deflection mirror 111 to a specific scanning position on the tested object 40 and directs the projection correction lens 94.

On the projection correction lens 94, the light flux diameter of the laser light 200 is adjusted in Y axis direction in the drawing, so that, when the laser light 200 is irradiated on the tested object 40, a range of a substantially circular shape is irradiated on the tested object 40. If the laser light 200 is a circular beam for example, it is projected obliquely relative to the tested object 40 so that an elliptical area with a major axis in the Z direction in the drawing on the tested object 40 is irradiated, deformation is generated in the image data. In this case, by adjusting to an elliptical beam with a minor axis in the Y axis direction in the drawing, it is possible to irradiate a circular range on the tested object 40, whereby an image without deformation in which scanning positions and the pixels of image data correspond one to one.

Movement of the projection correction lens 94 is identical to the explanations of the reference example.

The laser light 200 transmitted through the projection correction lens 94 is reflected on a light path which directs in a constant angle relative to the tested object 40 by the field mirror 112, and the laser light 200 is reflected by the tested object 40 and contacts the mirror 113 perpendicularly.

Therefore, the laser light 200 is specularly reflected by the mirror 113 and reversely advances the incident light path, re-directs the identical reflection position on the tested object 40, is re-reflected, reversely advances the above-mentioned light paths in order, and reaches beam splitter 109 in a state in which it is turned into a circular beam. The laser light 200 transmits through a branch surface of the beam splitter 109, a polarization state of the laser light 200 is controlled by the polarization plate 44B, forms an image on the light detection element 123 by the group of image formation lenses 103, detection signals in accordance with the brightness level are transmitted to the imaging control portion 118, and an image signal corresponding to a brightness level of a specific position on the tested object 40 is generated.

Following the scanning by the deflection mirrors 110, 111, the above-mentioned processes are repeated, the tested object 40 is two-dimensionally scanned by the laser light 200, and image data of the tested object 40 is obtained.

Whereby, image processing on the image data by the image processing portion 119 is conducted, so as to extract defects and determine the category of the defect or the like.

In this manner, in accordance with the surface defect inspection apparatus 502 of the present embodiment, the image data is recognized with the laser light 200 being output so that a laser light with a plurality of wavelengths has a substantially constant light intensity in terms of the wavelength sensitivity characteristics of the light detection element 123 by the wavelength compensation plate 107. Whereby, as explained in the reference example, unevenness in the brightness by the influence of the film thickness of the lower layer of the tested object 40 is aver aged, so that the influence of the lower layers is eliminated.

Also, since the laser light 200 is entered as the s-polarized light relative to the tested object 40, it is possible to detect defects appearing as the inclination in the refractive index with high accuracy.

Also, since the image data is obtained from the reflected light reflected by the tested object 40 twice, changes in brightness due to the defects are significant being proportional to the square of the reflectance.

Based on these, when performing defect detection by the image processing portion 119, it is possible to improve the accuracy in extracting defects since the image data of the defect part is not buried in noise and also it is in a significant state compared to normal data.

Also, in accordance with the present embodiment, it is advantageous in that the light detection element 123 can be made in simple constitution since image data can be obtained by two-dimensionally scanning the tested object 40 by the laser light 200 of beam shape.

Here, although the light detection element 123 does not perform imaging by itself and it practically performs imaging in combination with the Galvano-Mirror, it is described as an image capturing portion.

Next, a first modification example of the present embodiment will be explained.

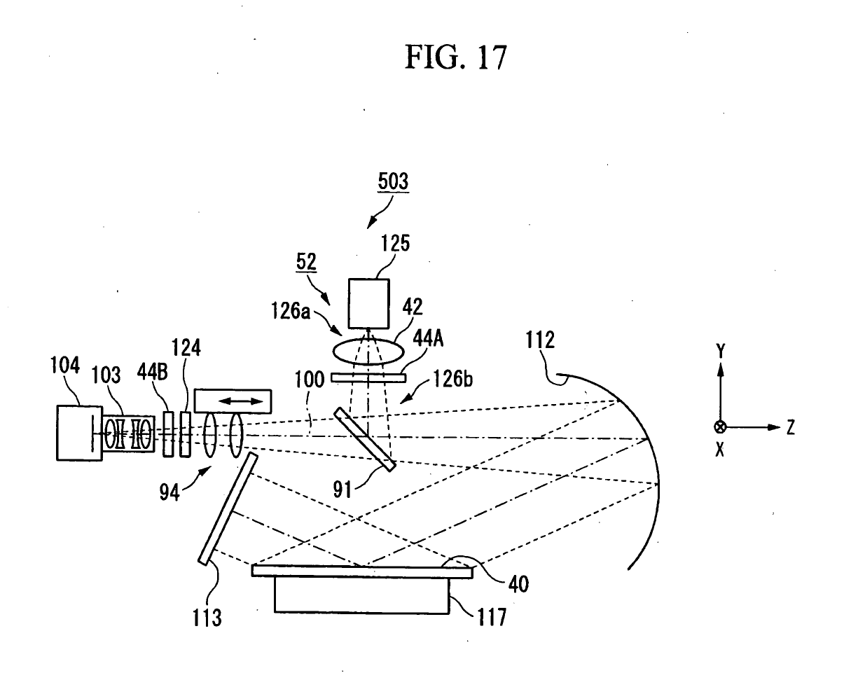

FIG. 17 is a front view showing a schematic view of the general construction of the surface defect inspection apparatus in accordance with the first modification example of the second embodiment of the present invention.

A surface defect inspection apparatus 503 of the present modification example is, as shown in FIG. 17, an apparatus to perform inspection by image capturing by way of irradiating an illumination light on the whole surface of the tested object 40. Instead of the illumination portion 51, the light detection element 123, and the wavelength compensation plate 107 of the above-mentioned second embodiment, a surface defect inspection apparatus 503 includes an image capturing element 104 such as illumination portion 52 and two-dimensional CCD or the like, and a wavelength compensation filter 124 (wavelength sensitivity correction filter), whereby directing the illumination light from a light path between the projection correction lens 94 and the field mirror 112 by using the half mirror 91. Hereinbelow, explanation will be given mainly to point out differences from the above-mentioned second embodiment.

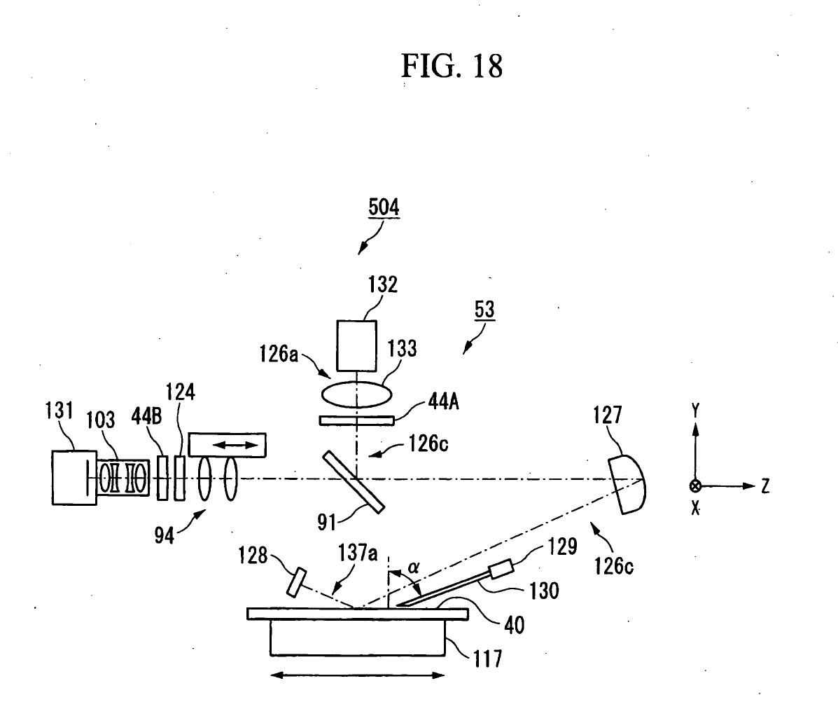

Here, control portion such as apparatus control portion 121 have substantially the same as previously described, therefore it is emitted in the drawings (emitted in below FIG. 18 to FIG. 28B as well).

The illumination portion 52 is formed by an illumination lamp 125 (light source), a condensing lens 42, and a polarization plate 44A arranged in this order.

The illumination lamp 125 is formed of a white LED light source and generates an illumination light 126a having a substantially optically white wavelength distribution. Here, three LEDs of R, G, B which are the three primary colors may be combined. The condensing lens 42 forms an illumination light 126b, in which the diffusing range is arranged in a predetermined range, by condensing the illumination light 126a.

The half mirror 91 is placed in the light path between the projection correction lens 94 and the field mirror 112. Therefore, when the illumination light 126b that is transmitted through the polarization plate 44A and its polarization state is changed to an s-polarized state relative to the tested object 40 is reflected by the half mirror 91, it enters the field mirror 112 and is reflected to a certain direction whereby it is possible to substantially irradiate onto the whole surface of the tested object 40.

The optical system provided before the field mirror 112 and the image capturing element 104 is designed so that it is possible to form an image on the image capturing element 104 at a position intersecting between the tested object 40 and the light path of the optical system, and the surface perpendicular to the light path 100 being an object surface. At this time, the tested object 40 is inclined. However, this it is dealt with by stopping down to sufficiently deepen the depth of field or by placing a focus adjustment mechanism.

The wavelength compensation filter 124 decompensates the wavelength distribution of the illumination lamp 125 to a wavelength distribution that is substantially white light relative to the wavelength sensitivity characteristics of the image capturing element 104. The wavelength compensation filter 124 is placed between the projection correction lens 94 and the group of image formation lenses 103. In this manner, in accordance with the present modification example, the wavelength sensitivity correction filter may be placed in a light path after a reflection at the tested object 40.

In accordance with the constitution of the present modification example, it is possible to irradiate the whole surface of the tested object 40 with a parallel light by the illumination light 126b formed by the illumination portion 52 which passes through the half mirror 91 and the field mirror 112. The illumination light 126b reflected by the tested object 40 is reflected by the mirror 113, re-reflected by the tested object 40, and returned to the field mirror 112, and transmits through the half mirror 91. By passing through the projection correction lens 94, the wavelength compensation filter 124, and the polarization plate 44B, the illumination light 126b forms an image by the group of image formation lenses 103 and is image captured by the image capturing element 104. Therefore, it is advantageous in that it is possible to obtain the image data of the tested object 40 at once.

Also, in accordance with the present modification example, it is advantageous in that it is constituted at low cost since the illumination portion 52 is constituted by the white color LED light source which is lower in cost than the laser light source and also a reversing mechanism such as deflection mirrors 110, 111 or the like is not necessary.

Next, explanation will be given of a second modification example of the present embodiment.

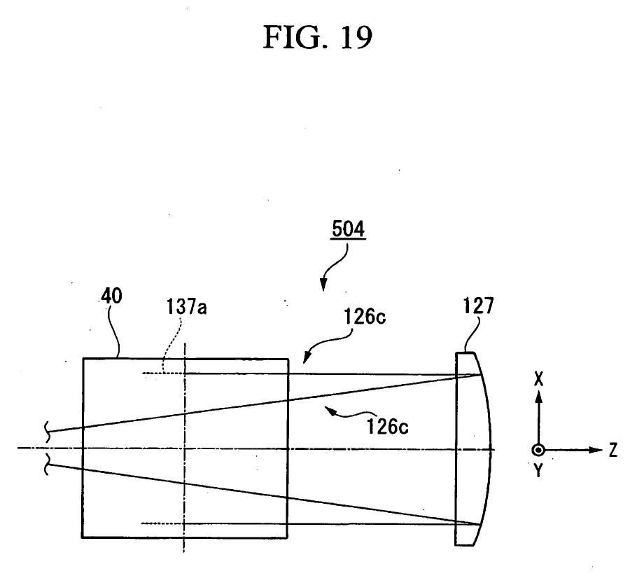

FIG. 18 is a front view showing a schematic view of the general construction of the surface defect inspection appear in accordance with the second modification example of the second embodiment of the present invention. FIG. 19 is a schematic plain view as well. Here, parts or rays of lights are arbitrarily omitted for easier view.

A surface defect inspection apparatus 504 of the present modification example is, as shown in FIGS. 17, 19, an apparatus to perform inspection on the tested object 40 by image capturing by way of irradiating a line illumination light. Instead of the illumination portion 52, the image capturing element 104, field mirror 112, and the mirror 113 of the above-mentioned first modification example of the second embodiment, the surface defect inspection apparatus 504 includes an illumination portion 53, a line image capturing element 131 (image capturing portion), field mirror 127, and a mirror 128 (reflection element) and it further includes a supplementary illumination portion 129 and a light guiding member 130. A movement mechanism in the Z axis direction in the drawing is placed on the specimen support 117, whereby movement in the Z axis direction is possible. Hereinbelow, explanation will be given mainly to point out differences from the above-mentioned first modification example of the second embodiment.

The illumination portion 53 is formed by a line illumination lamp 132 (light source), a cylindrical lens 133, and a polarization plate 44A arranged in this order to illuminate a line region extending in the X axis direction in the drawing on the tested object 40.

The line illumination lamp 132 is formed of a plurality of white LED light sources, which are provided with wavelength distribution characteristics identical to the illumination lamp 125 of the first modification example of the second embodiment, arranged in the X axis direction in the drawing.

The cylindrical lens 133 is an optical element to irradiate as a parallel light the illumination light 126a generated by the line illumination lamp 132 by way of the field mirror 127 (illumination optical system) in the YZ plane. Instead of turning the illumination light 126a into a parallel light, it is possible to reflect the illumination light 126a by the tested object 40 surface once and form an image as a line on the tested object 40 surface after being reflected by the mirror 128. Therefore, since the optical system is designed so that a region, in which the illumination light forms an image as a line on the tested object 40 surface, forms an image on the line image capturing element 131, whereby it is possible to obtain a brighter image.

Here, the polarization plate 44A is constituted in a band shape elongated in the X axis direction in the drawing in accordance with the transmission range of the illumination light 126a.

The line image capturing element 131 which is a line image capturing portion is a line image capturing element in which the sensor surface extends in the X axis direction in the drawing. For example, a line CCD provided with wavelength sensitivity characteristics identical to the image capturing element 104 may be employed. If a CCD provided with wavelength sensitivity characteristics different from the image capturing element 104 is used, compensation characteristics of the wavelength compensation filter 124 are changed in accordance with the wavelength sensitivity characteristics.

The field mirror 127 enters the illumination light 126c, which is irradiated from the illumination portion 53 and irradiated as a line in the X axis direction in the drawing, at a constant angle relative to the tested object 40 within the XZ plane in the drawing. Also, the field mirror 127 is an elongated mirror provided with a reflection surface to direct the major ray of light of the illumination light 126 to the tested object 40 in a direction perpendicular to the X axis direction in the drawing.

In the present modification example, the field mirror 127 is described as a free-form surface prism forming a rear surface mirror by filling a portion of the light path with a medium. Here, the field mirror 127 may be formed elongated in X axis direction by cutting upper and lower portions of the Y axis direction except in the vicinity of the intersection with the light axis 100 of the field mirror 112. Also, a cylindrical mirror with parabolic cross section may be employed.

The mirror 128 is, the same as the mirror 113, a mirror to specularly reflect the illumination light reflected by the tested object 40. The mirror 128 is different from the mirror 113 only in size due to a difference in the shape of the irradiation region.

The supplementary illumination portion 129 is a light source to perform line illumination and improve the detection sensitivity relative to foreign materials or the like attached on the tested object 40. A constitution identical to the line illumination lamp 132 can be employed for example. However, a light source with a different wavelength distribution may be employed so that the supplementary illumination portion 129 is easily in contrast with the illumination light 126c

The light guiding member 130 is a member to guide a illumination light generated at the supplementary illumination portion 129 to the vicinity of the tested object 40 to direct the illumination light to the tested object 40 with a large incident angle such as 85° to 90° (angle α in the drawing). For example, such a constitution may be employed in that a flat glass plate in which an illumination light generated at the supplementary illumination portion 129 totally reflects thereinside and cuts an edge portion of a side closer to the tested object 40 in arbitrary angle to obtain an output direction corresponding to the above-mentioned incident angle.

In accordance with such a constitution, since it is different from the first modification example of the second embodiment only in that an irradiation region of the illumination light on the tested object 40 is a line, it is apparent that an effect identical to the first modification example with regard to the line irradiation region can be obtained. Here, in the present modification example, by moving the specimen support 117 in the Z axis direction in the drawing to move the irradiation region of the illumination light on the tested object 40, it is possible to obtain the whole image of the tested object 40.

In accordance with the present modification example, since a light path, in which the illumination lights 126s, 126c, and their reflected lights are distributed as a line, is formed, it is possible to miniaturize optical elements such as the wavelength compensation filter 124, the field mirror 127, the mirror 128, the half mirror 91, the polarization plates 44A and 44B for example, it is possible to miniaturize the apparatus. Also, since it is easy to produce optical elements, it is possible to produce them at low cost.

Also, in accordance with the present modification example, since the surface defect inspection apparatus 504 is provided with the supplementary illumination portion 129 and the light guiding member 130, it is possible to perform illumination by the supplementary illumination portion 129 in accordance with the illumination of the illumination light 126c.

Since the illumination light from the supplementary illumination portion 129 has a large incident angle, it is not observed among the illumination light 126c in general. However, when foreign materials or the like are attached on the tested object 40, its scattering light is observed. That is, it is possible to generate a reflected light (scattering light) with a high contrast difference compared to the illumination light 126c from the foreign materials on the surface of the tested object 40, and it is advantageous in that it is possible to improve foreign materials detection sensitivity.

Next, explanation will be given on a third modification example of the present embodiment.

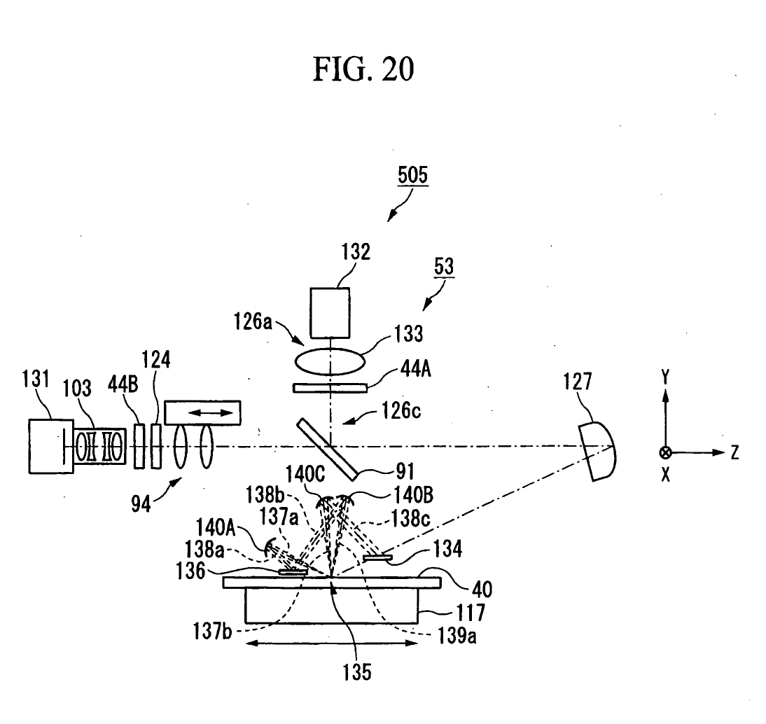

FIG. 20 is a front view showing a schematic view of the general construction of the surface defect inspection apparatus in accordance with the third modification example of the second embodiment of the present invention.

In the above-mentioned second modification example of the second embodiment, a surface defect inspection apparatus 505 of the present modification example is constituted, as shown in FIG. 20, so that it changes the optical system which directs the illumination light 126c to the tested object 40. Whereby, when reflected by the tested object 40 twice, each of the reflections are performed with a different incident angle relative to the tested object 40. Here, the supplementary illumination portion 129 and the light guiding member 130 may be provided. However, they are omitted in FIG. 20.

Therefore, the general construction of the present modification example is constituted such that, instead of mirror 128 of the second modification example of the second embodiment, the surface defect inspection apparatus 505 includes an optical system including a half mirror 134, paraboloid mirrors 140A, 140C, a paraboloid mirror 140B (reflection element), and a flat mirror 136. Hereinbelow, explanation will be given mainly to point out differences from the above-mentioned second modification example of the second embodiment.

The half mirror 134 is a light path branch portion member to branch the light path between the field mirror 127 and the tested object 40.

As reflection surfaces, the paraboloid mirrors 140A, 140B, and 140C are all provided with paraboloidal surfaces, in which the illumination region 135 which is transmitted through the half mirror 134 and contacts the tested object 40 is a focus position.

The paraboloid mirror 140A is placed in the same position as the mirror 128 and reflects the reflected light 137a by the tested object 40 from the illumination light 126c to a side of the tested object 40 as a parallel light 138a.

On the light path of the parallel light 138a above the tested object 40, the flat mirror 136, which reflects the parallel light 138a in an upper diagonal direction (Y axis positive direction in the drawing), is placed.

The paraboloid mirror 140B is placed in a position which is able to reflect the parallel light 138b toward the illumination region 135 as a convergent light 139a.

The paraboloid mirror 140c is placed in such a position that the re-reflected light 137b, in which the convergent light 139a is re-reflected by the tested object 40, is reflected toward the half mirror 134 as a parallel light 138c and at the same time the parallel light 138c advances along the identical light path to the illumination light 126c by way of the half mirror 134.

In accordance with this kind of constitution, the illumination light 126c transmits through the half mirror 134 and is reflected by the illumination region 135 and becomes the reflected light 137a. The reflected light 137a contacts the flat mirror 136 as the parallel light 138a, which is reflected by the paraboloid mirror 140A, and is reflected toward the paraboloid mirror 140B as the parallel light 138b. The parallel light 138b is converged by the paraboloid mirror 140B, whereby it re-directs illumination region 135 as a convergent light 139a.

At this time, the incident angle to the tested object 40 is, as shown in FIG. 20, different from the incident angle of the illumination light 126c.

The re-reflected light 137b re-reflected by the tested object 40 is reflected toward the half mirror 134 by the paraboloid mirror 140c as the parallel light 138c. The parallel light 138c reversely advances along the light path of the illumination light 126c and an image is formed on the line image capturing element 131 the same as the second modification example. In this manner, image data for one line is obtained and the specimen support 117 is moved in the Z axis direction and by repeating such processes, image data of whole surface of the tested object 40 is obtained.

In accordance with the present modification example, the same as the second modification example of the second embodiment, it is possible to obtain image data by reflecting the line illumination light onto the tested object 40 twice. Further more, it is possible to set the incident angle at the two-time-reflection different.

That corresponds to a case in which the light changes an angle φ, with which the light advances in the film in formulaes (8), (9) as shown in the formula (10). Therefore, interference patterns due to the two reflections are different, and the interference patterns are averaged as a whole. Whereby, it is possible to reduce unevenness in brightness due to the interference. Consequently, it is possible to further reduce the influence of the inclination in the refractive index or unevenness in the film thickness, whereby it is possible to improve defect detection accuracy.

Next, an explanation will be given of a fourth modification example of the present embodiment.

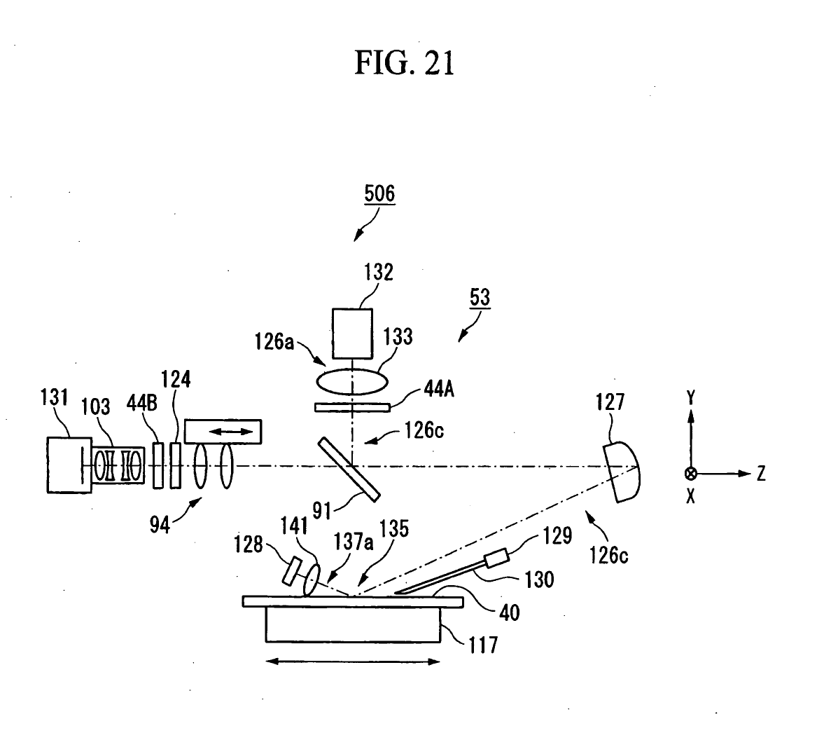

FIG. 21 is a schematic front view of the general construction of the surface defect inspection apparatus in accordance with the fourth modification example of the second embodiment of the present invention.

A surface defect inspection apparatus 506 in accordance with the present modification example is, as shown in FIG. 21, an apparatus to perform inspection by image capturing the tested object 40 by way of irradiating the line illumination light. It is equivalent to the above-mentioned second modification example of the second embodiment which is provided with an illumination condensing lens 141 on the light path of the reflected light 137a between the tested object 40 and the mirror 128. Hereinbelow, explanation will be given mainly of the differences from the above-mentioned second modification example.

The illumination condensing lens 141 is a lens array in which lenses corresponding to the pixels of the line image capturing element 131 to image capture the illumination region 135 are arranged in the X axis direction in the drawing. A reflected light from a region corresponding to the imaging pixels on the illumination region 135 is condensed and an image is formed on the mirror 128. That is, the mirror 128 and the illumination region 135 are placed in a conjugated relationship.

In accordance with the constitution of the present modification example, the reflected light 137a forms an image on the mirror 128 by being condensed for each of the reflected lights of regions corresponding to the pixels of the line image capturing element 131 by the illumination condensing lens 141.

Because the mirror 128 is formed of a mirror surface, substantially all the reflected light from the mirror 128 is condensed by the illumination condensing lens 141 and an image is re-formed on the tested object 40.

Therefore, it is possible to obtain a bright image since the illumination light 126c is effectively illuminated in the direction an image is taken. Also, since the illumination light 126c is reflected twice on the illumination region 135 correctly corresponding to the pixels of the image capturing element 131 and is finally image captured by the line image capturing element 131, image information obtained by the respective pixels hardly contains information on other irradiation regions such as regions of adjacent pixels for example. Whereby, it is possible to obtain image data of the tested object 40 in high accuracy. Consequently it is possible to improve defect detection sensitivity.

Next, an explanation will be given of a fifth modification example of the present embodiment.

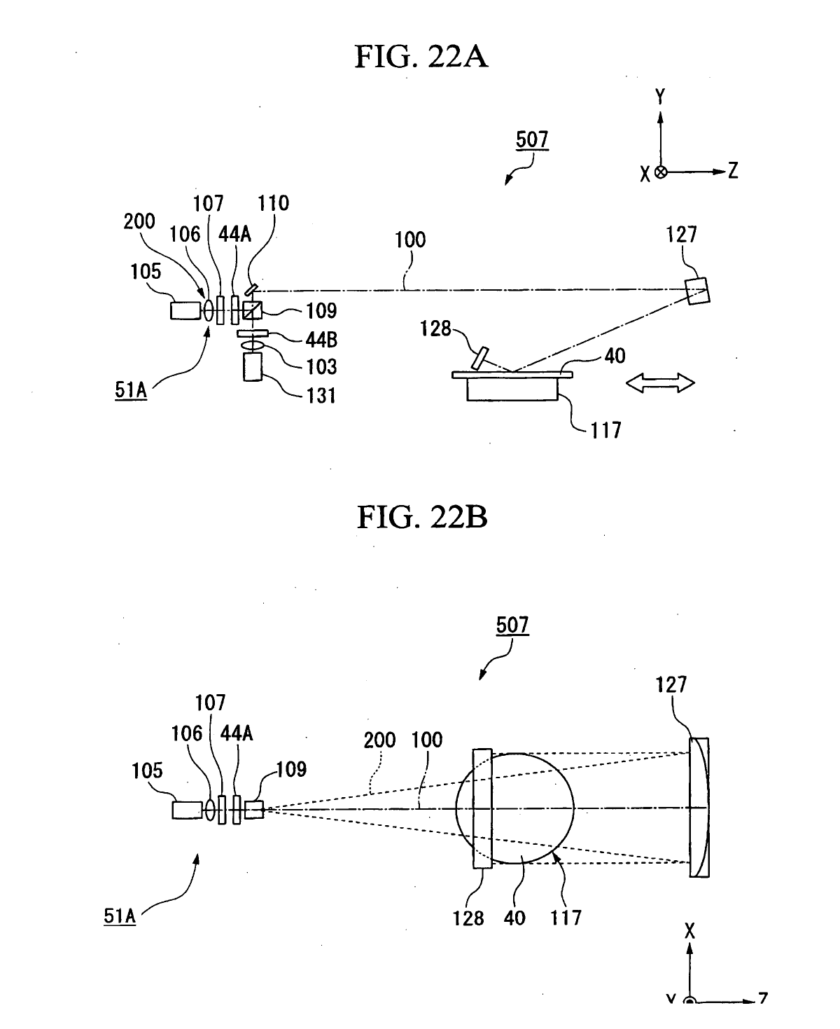

FIGS. 22A, 22B are schematic front and plain views of the general construction of the surface defect inspection apparatus in accordance with the fifth modification example of the second embodiment of the present invention.

A surface defect inspection apparatus 507 of the present modification example is, as shown in FIGS. 22A, 22B, an apparatus to perform inspection by imaging the tested object 40 by irradiating the line illumination light. It is equivalent to the above-mentioned second embodiment in which the deflection mirror 111, a reversing mechanism 111A, and the projection correction lens 94 are deleted, and instead of the illumination portion 51, the field mirror 112, and the mirror 113, an illumination portion 51A, the field mirror 127, and the mirror 128 of the above-mentioned second embodiment are respectively provided. Hereinbelow, explanation will be given mainly of the differences from the above-mentioned second embodiment.

The illumination portion 51A is provided with the line image capturing element 131 instead of the light detection element 123 of the illumination portion 51 of the above-mentioned second embodiment. In order to defectively scan the laser light 200 reflected by the deflection mirror 110 in the X axis direction within the ZX plane in the drawing, the laser light 200 is irradiated from the laser emitting diode 105 in the positive Z axis direction in the drawing, is reflected by the beam splitter 109 in the positive Y axis direction in the drawing, and is guided to the deflection mirror 110. Therefore, the line image capturing element 131 is designed such that it image captures light transmitting in the negative Y axis direction from the beam splitter 109.

The arranged positions of the field mirror 127 and the field mirror 128, and the specimen support 117 movable in Z axis direction to move the tested object 40 are identical to those of the above-mentioned second modification example of the second embodiment.

That is, the present modification example is identical to an embodiment in which the illumination portion 53 having the line illumination lamp 132 of the above-mentioned second modification example of the second embodiment is transformed to the illumination portion 51A due to the one-dimensional scan of the deflection mirror 110.

In accordance with the present modification example, the laser light 200 guided to the deflection mirror 110 is defectively scanned within the ZX plane in the drawing, and the laser light 200 is irradiated by the field mirror 127 onto a line irradiation region of the tested object 40 on the X axis in the drawing. After the reflected light thereof is reflected by the mirror 128 and re-reflected at the reflection position, it reversely advances the light path to form an image on the line image capturing element 131 and is image captured. Being synchronized with the above movements, the tested object 40 is scanned two-dimensionally by moving the specimen support 117 in the Z axis direction in the drawing.

Next, an explanation will be given of a sixth modification example of the present embodiment.

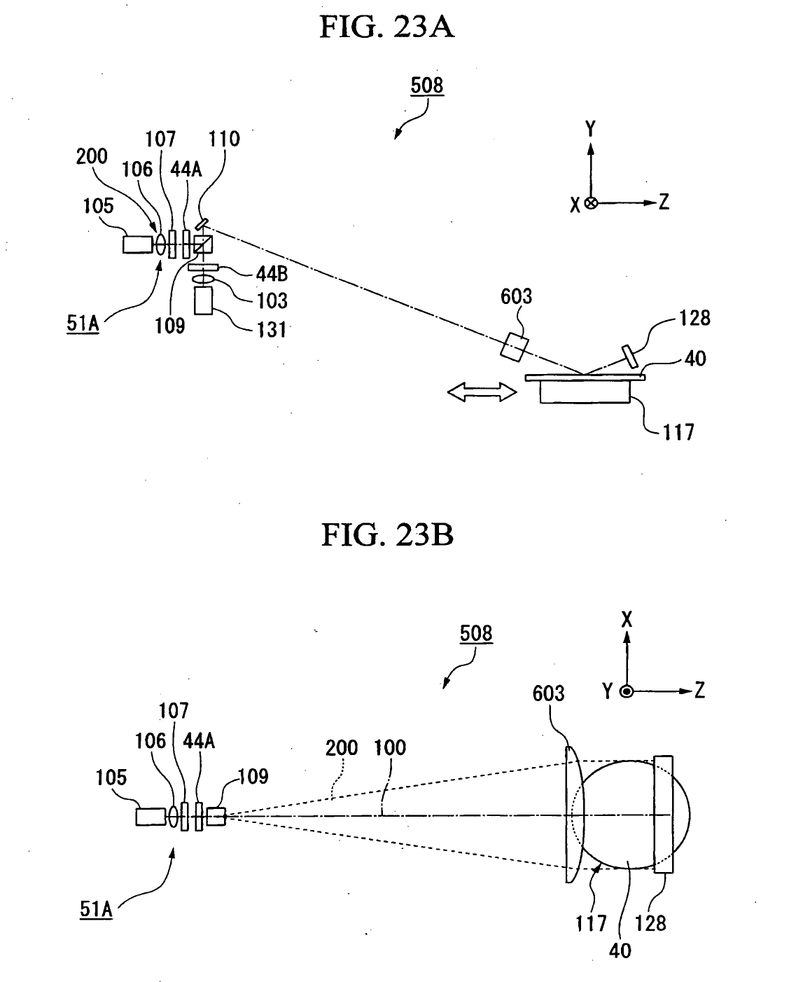

FIGS. 23A, 23B are schematic front and plain views of the general construction of the surface defect inspection apparatus in accordance with the sixth modification example of the second embodiment of the present invention.

A surface defect inspection apparatus 508 of the present modification example is, as shown in FIGS. 23A, 23B, instead of the field mirror 127 of the fifth modification example of the second embodiment, provided with a field lens 603 (illumination optical system), and corresponding to that, arranged positions of respective constituent elements are arbitrarily changed. That is, by placing the deflection mirror 110 in an arbitrarily inclined angle, the laser light 200 from the illumination portion 51A is defectively scanned so as to pass through the light path after the reflection at the field mirror 127 of the above-mentioned fifth modification example and directs with the same incident angle relative to the tested object 40. And by placing the field lens 603 in the light path between the deflection mirror 110 and the tested object 40, the line irradiation region, which follows the X axis direction in the drawing, is illuminated on the tested object 40. Hereinbelow, explanation will be given mainly of differences from the above-mentioned fifth modification example of the second embodiment.

The field lens 603 is an elongated lens to make the major ray of light of the laser light 200 advance in a direction intersecting at right angles with the line irradiation region at respective scanning positions and is formed of an aspherical lens.

In FIGS. 23A, 23B, the light path between the deflection mirror 110 and the field lens 603 are not folded back; however the light path may arbitrarily be folded back by placing a reflection mirror to make the constitution more compact.

Since the surface defect inspection apparatus 508 of the present modification example is provided with the field lens 603 instead of the field mirror 127, it has the identical effect of the above-mentioned fifth modification example.

Next, an explanation will be given on a seventh modification example of the present embodiment.

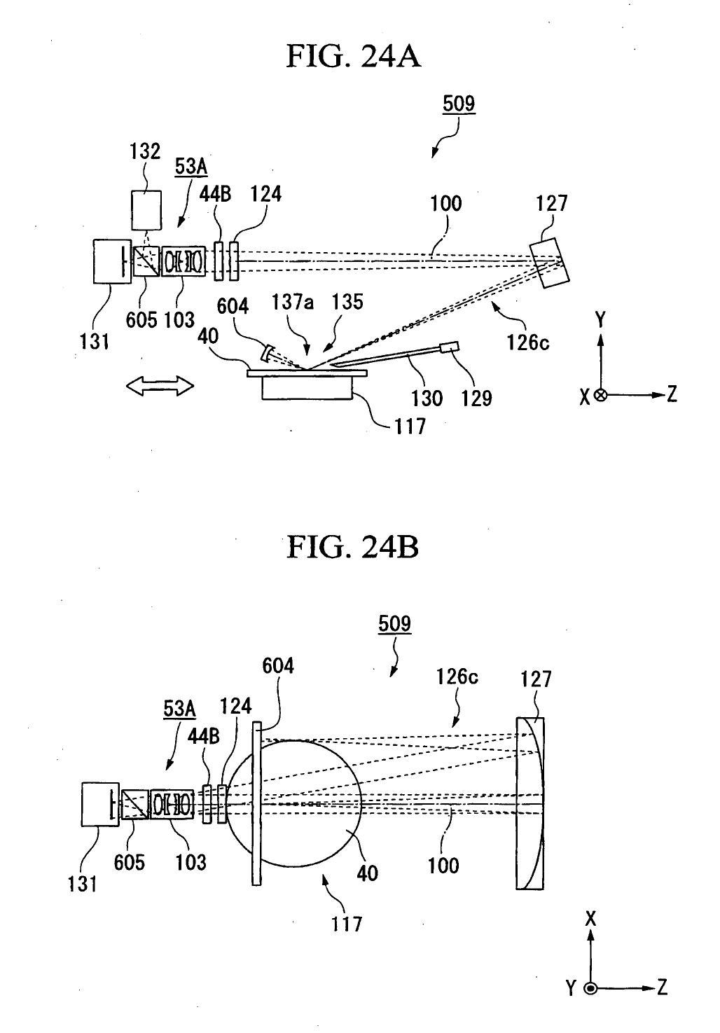

FIGS. 24A, 24B are schematic front and plain views of the general construction of the surface defect inspection apparatus in accordance with the seventh modification example of the second embodiment of the present invention.

A surface defect inspection apparatus 509 of the present modification example is, as shown in FIGS. 24A, 24B, an apparatus to perform inspection on the tested object 40 by image capturing by irradiating a line illumination light. It is equivalent to the above-mentioned fourth modification example of the second embodiment in which the cylindrical lens 133, the polarization plate 44A, the half mirror 91, and the projection correction lens 94 are deleted, and instead of the mirror 128, and the illumination condensing lens 141, a concave mirror 604 is provided and a half-mirror cube 605 is added. Here, the supplementary illumination portion 129 may be omitted. Hereinbelow, explanation will be given mainly to point out differences from the above-mentioned fourth modification example of the second embodiment.

The concave mirror 604 is an elongated mirror provided with a reflection surface of aspherical shape which re-forms an image of the light reflected by the tested object 40 at the same reflection position. Therefore, the constitution is such that functions of the mirror 128 and the illumination condensing lens 141 of the above-mentioned fourth modification example of the second embodiment are performed by one part.

The half-mirror cube 605 is a light path combining portion placed in the light path between the line image capturing element 131 and the group of image formation lenses 103. The half-mirror cube 605 is provided with a half mirror surface that reflects light from the illumination lamp 132, directs the light along the light axis of the group of image formation lenses 103, transmits the light reflected from the tested object 40 to return to the group of image formation lenses 103, and guides the light onto the line image capturing element 131.

The line image capturing element 131, the half-mirror cube 605, and the group of image formation lenses 103 constitute an illumination portion 53A which is integrated with the image capturing portion which is formed of the line image capturing element 131.

Because of this kind of constitution, even if the cylindrical lens 133 is deleted, it is possible to locate the line image capturing element 131 and the line illumination lamp 132 in a position which is optically conjugated. Therefore, it is possible to reduce the number of parts and achieve miniaturization, whereby it is possible to reduce light quantity loss.

Next, an explanation will be given on an eighth modification example of the present embodiment.

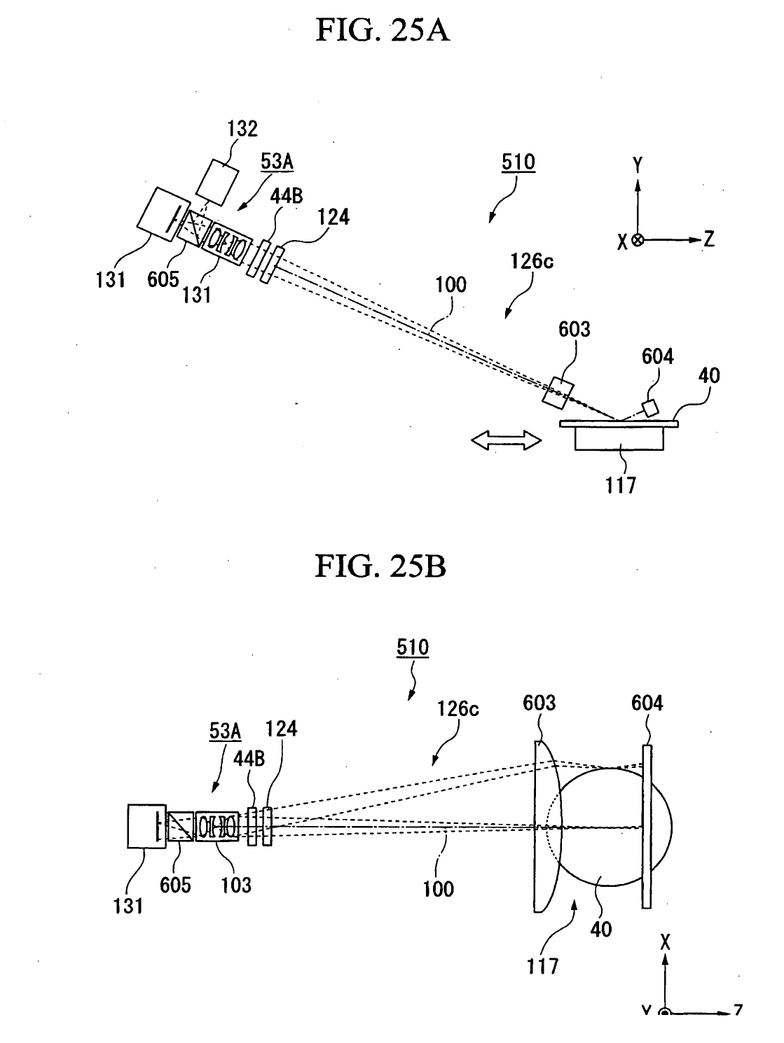

FIGS. 25A, 25B are schematic front and plain views of the general construction of the surface defect inspection apparatus in accordance with the eighth modification example of the second embodiment of the present invention.

A surface defect inspection apparatus 510 of the present modification example is, as shown in FIGS. 25A, 25B, provided with the field lens 603 instead of the field mirror 127 of the above-mentioned seventh modification example of the second embodiment, whereby arranged positions of the respective constituent elements are changed corresponding thereto. That is, the constituent elements are arranged so that the illumination light 126c irradiated from the illumination lamp 132 directs with the same incident angle relative to the tested object 40 by passing through the same light path after the reflection by the concave mirror 604 of the above-mentioned seventh modification example. By placing the field lens 603 in the light path between the wavelength compensation filter 124 and the tested object 40, the line irradiation region on the tested object 40 following the X axis direction in the drawing is arranged to be illuminated.

The supplementary illumination portion 129 is omitted in the drawing but is placed in the same position as the above-mentioned seventh modification example.

In FIGS. 25A, 25B, although a constitution in which a light path between the group of image formation lenses 103 and the field lens 603 is not folded back, the light path may be arbitrarily folded back for a simpler constitution by placing a reflection mirror.

Since the surface defect inspection apparatus 510 of the present modification example is provided with the field lens 603 instead of the field mirror 127, it has effects identical to the above-mentioned seventh modification example.

Next, an explanation will be given of a ninth modification example of the present embodiment.

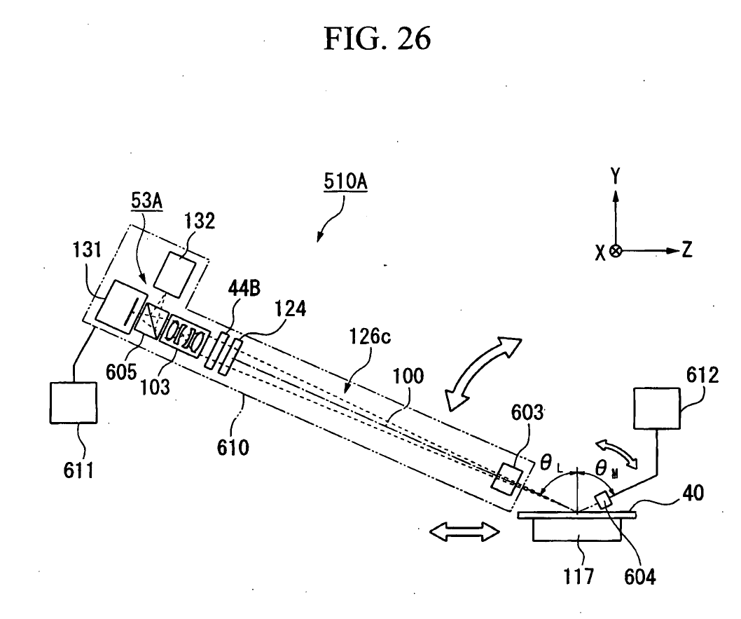

FIG. 26 is a front view showing a schematic view of the general construction of the surface defect inspection apparatus in accordance with the ninth modification example of the second embodiment of the present invention.

A surface defect inspection apparatus 510A of the present modification example is, as shown in FIG. 26, in the surface defect inspection apparatus 510 of the above-mentioned eighth modification example of the second embodiment, the illumination portion 53A, the polarization plate 44B, the wavelength compensation filter 124, the field lens 603, and the line image capturing element 131 are retained to an arbitrary chassis to form an optical unit 610. Furthermore, the surface defect inspection apparatus 510A is movably retained within the YZ plane with the line irradiation-region as the center by the reversing mechanism 611 as well as a concave mirror 604 being movably retained within the YZ plane with the line irradiation region as the center by the reversing mechanism 612.

The reversing mechanisms 611, 612 are each connected to the control portion 101 omitted in the drawing so that their turning positions are controlled. That is, when an incident angle of a light irradiated from the optical unit 610 relative to the tested object 40 is set to θ_{L}, and its reflection angle is set to θ_{M}, then θ_{L} and θ_{M} are able to be controlled mutually and independently.

Here, a movement of the surface defect inspection apparatus 510A of the present modification example will be explained.

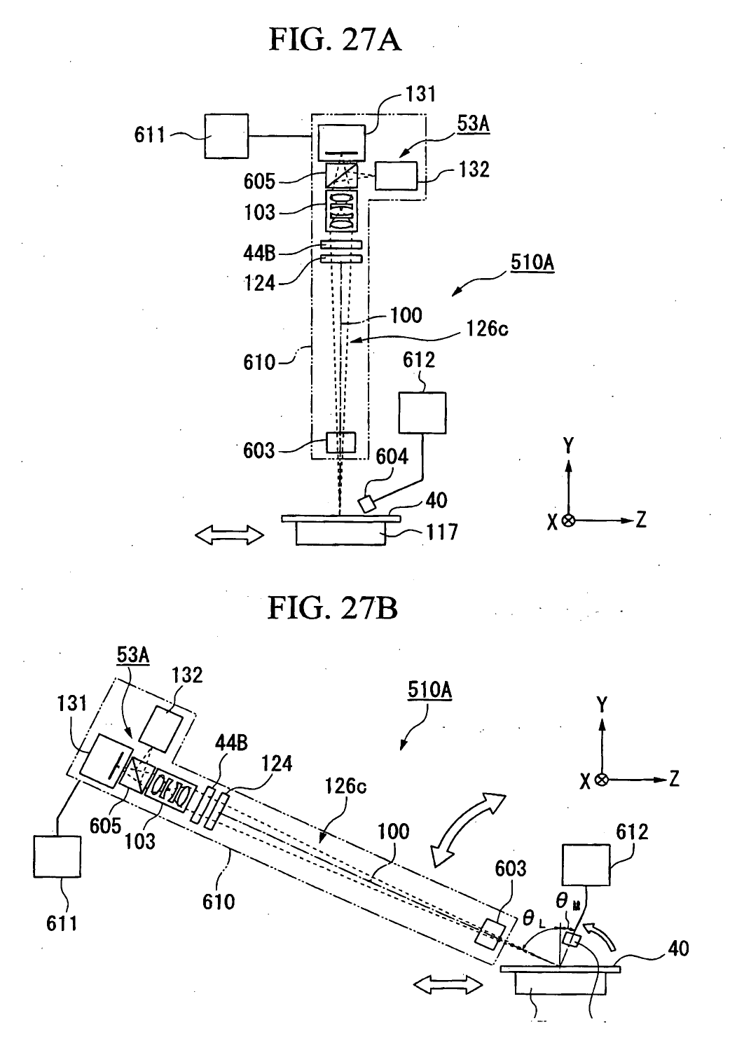

FIGS. 27A, 27B are front views of an explanatory movement diagram showing the movement of the surface defect inspection apparatus in accordance with the ninth modification example of the second embodiment of the present invention.

In accordance with the surface defect inspection apparatus 510A, various surface inspections can be switched and performed by controlling angles θ_{L}, θ_{M} with the reversing mechanisms 611, 612.

For example, a movement example shown in FIG. 27A shows a case in which the θ_{L} is set to 0°.

In this case, a co-axial vertical lighting optical system, in which the incident angle and the reflection angle are 0°, can be achieved. In this kind of the co-axial vertical lighting optical system, since it is not a grazing-incidence, the aspect ratio of images that the image capturing portion obtains become the same, whereby projection correction is not necessary. Also, it is possible to only image capture specular reflected light without being influenced by the diffracted light. Also, since there is no difference between the s-polarized light and the p-polarized light, it is possible to remove the polarization plate 44B from the light path, and advantageous in that it is possible to observe a bright image.

In this case, since light is not allowed to direct the concave mirror 604, the angle θ_{M} can be arbitrarily set.

Also, a movement example shown in FIG. 27B shows a case in which the θ_{L} is set from 0° to 90° and the θ_{M} is set to a different angle from θ_{L} such as θ_{L}>θ_{M} or the like.

In this case, light that has directed to the tested object 40 is not re-directed to the optical unit 610 by returning to the identical light path by way of the concave mirror 604. Therefore, for example, when foreign materials or scratches are on the surface of the tested object 40, only their scattering light re-directs the optical unit 610 and is image captured by the line image capturing element 131. Therefore, by moving the specimen support 117 in the Z axis direction in the drawing and obtaining the images due to the scattering light, it is possible to perform image capturing corresponding to a dark field observation.

Also, at this time, by setting the angle θ_{L} as an arbitrary angle corresponding to a pattern formed on the surface of the tested object 40, it is possible to image capture diffracted light generated from the pattern on the surface of the tested object 40. Since this kind of diffracted light has a characteristic in which the diffraction angle or the brightness value changes significantly due to a cycle or shape of the pattern formed on the surface of the tested object 40, whereby it is possible to perform pattern defect detection by using this kind of characteristic. Here, in this case, the concave mirror 604 is evacuated to an angle in which unnecessary lights do not enter the observation.

Here, in the present modification example and the above-mentioned eighth modification example, instead of the concave mirror 604, the mirror 128 may be used if needed.

Next, an explanation will be given of a tenth modification example of the present embodiment.

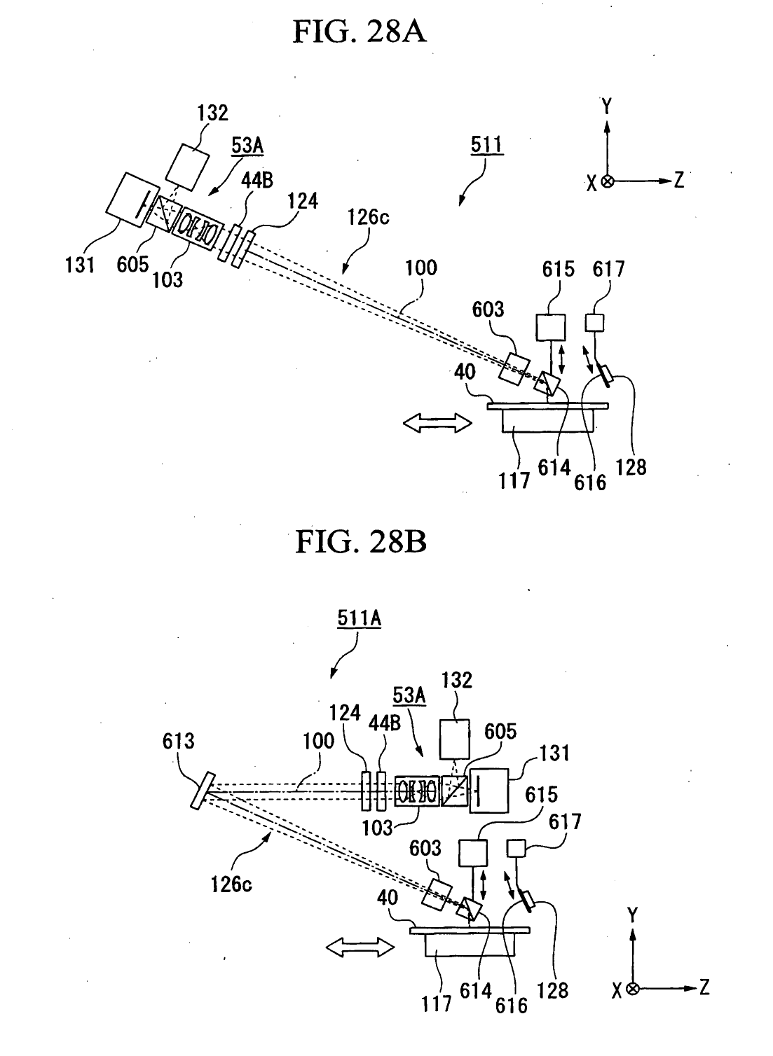

FIG. 28A is a front view showing a schematic view of the general construction of the surface defect inspection apparatus in accordance with the tenth modification example of the second embodiment of the present invention.

A surface defect inspection apparatus 511 of the present modification example is, as shown in FIG. 28A, in the surface defect inspection apparatus 510 of the above-mentioned eighth modification example of the second embodiment, instead of the concave mirror 604, the mirror 128 is provided and a mirror-cube 614 and a scattering plate 616 are added. Hereinbelow, explanation will be given mainly of the differences from the above-mentioned eighth modification example.

The mirror-cube 614 is movably retained forward and backward by an extraction and retraction mechanism 615 relative to a light path (hereinbelow called an incident light path) between the field lens 603 the tested object 40. In a state of being advanced into the incident light path, the mirror-cube 614 reflects the illumination light 126c so that the reflected light enters the tested object 40 at a right angle. The mirror-cube 614 is an elongated reflection member arranged as mentioned above. When the mirror-cube 614 is removed from the incident light path, the light reflected by the tested object 40 directs the mirror 128 at right angle.

When the mirror-cube 614 is extracted to the incident light path, the illumination light 126c is specularly reflected by the tested object 40 and reversely advances the light path. That is, the co-axial vertical lighting optical system is formed.

The position of the mirror-cube 614 is set so that a light, which forms an image on the line image capturing element 131 by arrangement of the light path length, comes within the depth of field of the group of image formation lenses 103.

The optical characteristics of the scattering plate 616 can be switched to the optical characteristics of a transparent plate, a scattering plate, or a light shield plate due to an identical constitution to the electrical-powered scattering plate 602. The scattering plate 616 is retained movably forward and backward by the extraction and retraction mechanism 617 relative to a light path (hereinbelow it is called a re-incident light path) between the mirror 128 and the tested object 40.

The extraction and retraction mechanisms 615, 617 are controlled respectively by the control portion 101 emitted in the drawing.

For example, if the scattering plate 616 is set as a scattering plate, it is possible to make a light re-directing the tested object 40 from the mirror 128 a scattering light by removing the mirror-cube 614 from the incident light path and extracting the scattering plate 616 to the re-incident light path.

Furthermore, by removing the scattering plate 616 from the re-incident light path or by setting the optical characteristics of the scattering plate 616 as that of a transparent plate, an incident light toward the scattering plate is specularly reflected by the mirror 128, is re-directed into the reflection position of the tested object 40 and reflected, it is possible to make a state in which the line image capturing element 131 can image capture the light.

Also, by setting the scattering plate 616 as a light shield plate and extracting to the re-incident light path, it is possible to shield and absorb the light directing the scattering plate 616 and not to allow the light to return to the tested object 40.

In the present modification example, by mixing the extraction and retraction of the mirror-cube 614 with setting of the optical characteristics and extraction and retraction of the scattering plate 616, it is possible to switch the surface defect inspection apparatus 511 to the co-axial vertical lighting optical system, a dark field observation optical system, or a scattering light observation optical system, whereby each of these can be switched and can performs inspection corresponding to a category of the defect to be observed.

Next, an explanation will be given of an eleventh modification example of the present embodiment.

FIG. 28B is a schematic front view of the general construction of the surface defect inspection apparatus in accordance with the eleventh modification example of the second embodiment of the present invention.

A surface defect inspection apparatus 511A of the present modification example is, as shown in FIG. 28B, in the surface defect inspection apparatus 511 of the above-mentioned tenth modification example of the second embodiment, a mirror 613 is provided in the light path between the wavelength compensation filter 124 and the field lens 603, whereby the constitution becomes compact by folding back the light path.

In the above with respect to the illumination portion, explanation is given with an example such that a plurality of light sources is condensed by a single condensing lens. However, the constitution may be that the condensing lens is provided for the respective plurality of light sources.

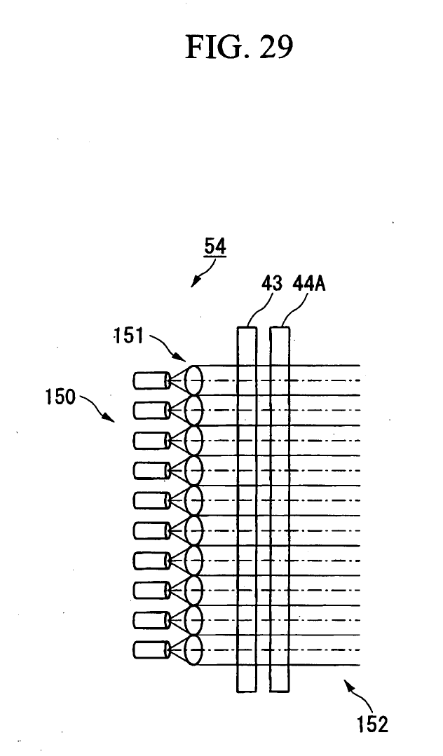

FIG. 29 is an explanatory schematic front view to explain other illumination portions which can be used for each of the embodiments of the present invention.

An illumination portion 54, which is one of the examples of this kind of constitution, is constituted by a plurality of LEDs 150 two-dimensionally provided along the depth direction in the drawing and a plurality of micro lens 151 provided on the side of respective irradiating openings of the plurality of LED 150 to condense an illumination light 152 generated by the plurality of LEDs 150 to a predetermined light flux diameter.

The LED 150 is placed by mixing three kinds of wavelengths thereof corresponding to RGB, for example, whereby an array of white LED light sources is formed.

Each of the illumination light 152 is irradiated toward the tested object 40 by transmitting through the compensation filter 43 and the polarization plate 44A. At this time in FIG. 29, although each of the illumination lights 152 is described schematically as a group of beams which do not mutually overlap, the each of the illumination lights 152 is scattered slightly so that a region having a substantially equal diameter is irradiated at the position of the tested object 40.

In the above, although an explanation is given with an example of turning the polarization state of the incident light to the tested object into the s-polarized light, the first polarization plate may be deleted by setting the incident light to the tested object at Brewster's angle. At Brewster's angle, as shown in FIG. 9, since the reflected light from the tested object turns the s-polarized light only, it is possible to control the polarization state of the reflected light from the tested object without placing the first polarization plate.

Also, in the above-described explanations on the first embodiment, in the projection correction lens 94 which is an optical element that elongates and contracts the image of the tested object only in one direction, an explanation was given by an example of the first lens group G1 as a moving group and the second lens group G2 as a fixed group. However, the constitution for turning the combined power of the optical element is not limited to this kind of constitution.

Also, in the above, as an optical element for elongating and contracting the image of the tested object only in one direction, an explanation is given with an example constituted by the group of cylindrical lenses. However, the optical element is not limited to this. As an example of an optical element without power, an optical element constituted by a prism or a group of prisms whose inclination angle relative to a light axis is variable and an optical element such as DOE or the like which corrects dispersion by color may be employed.

Also, in the above, an explanation is given with an example in which the first polarization plate is provided in the vicinity of the observation position. However, as long as it is placed between the tested object and the observation position, it may be placed in any position. For example, in a surface defect inspection apparatus using the half mirror 91, the polarization state may be controlled by using a polarization beam splitter instead of the half mirror 91. In this case, since the polarization beam splitter functions as the polarization plate, the constitution can be simplified by eliminating the polarization plate 44B.

Also, in the above, in a constitution in which a light path for visual observation and a light path for observation by image capturing can be switched, an explanation is given for the case of a wavelength sensitivity correction filter being provided with characteristics arranged for visual observation. However, the wavelength sensitivity correction filter provided with optimal wavelength characteristics for each of the observation methods may be manually or automatically switched, in accordance with the switches of the light path.

Also, in the above of the second embodiment, an explanation is given with such an example that a whole surface image of the tested object 40 is obtained by two-dimensionally scanning the laser light 200 with the deflection mirrors 110, 111. The two-dimensional scanning may be achieved by combining the one-dimensional scannings in a manner such that after one-dimensionally scanning the laser light 200, the tested object is moved in the perpendicular direction by the specimen support 117.

Also, image capturing may be performed by placing a one-dimensional line sensor, instead of the light detection element 123, and by placing a deflection mirror which scans one-dimensionally in a direction perpendicular to the elongated direction of the line sensor.

Also, in the above, an explanation is given with an example such that the illumination light directs the tested object once or twice. However, it may direct three times or more. The more the number of reflections, the more changes in the film thickness or the influence of the inclination in the refractive index of the multi-layer film reflection are emphasized in power-law. Therefore, it is advantageous in that it shows more significant changes in brightness.

Here, in this case, it is assumed that reflectance due to the increase in the number of reflections or light quantity due to the influence of scattering, significantly decrease. Therefore, it is preferable to employ light sources with less scattering or a laser beam as light sources. Also, as described above, it is possible to use a single color laser since it is possible to perform observation by decreasing influences due to the unevenness in lower films even when the illumination light is a single color, provided that light contacts the tested object at incident angles of a plurality of conditions and its combined ray of light is detected.

Also, in the above explanations of the third modification example of the second embodiment, an explanation is given with such an example that, as a reflection element which is re-entry optical system, the paraboloid mirror is used. However, as long as it is an optical system which can converts parallel light to and convergent light and vice versa, the curving shape is not limited to paraboloid surface but arbitrary free-form surface can be employed. Also, as long as the rage is not influenced by aberration or the like, it may be a cylindrical concave mirror using a spherical shape, or as long as the light quantity loss is not a problem, it may be a flat mirror.

Also, the reflection element is not necessarily be re-directed as a convergent light if the illumination light reflected by the tested object is able to be re-directed to the irradiation region.

Also, in the above explanations of the fourth modification example of the second embodiment, an explanation is given with such an example that the illumination condensing lens 141 is used. However, instead of the mirror 128, an aspherical mirror may be employed which is provided with such an optical effect that reflected light from the tested object pixel by pixel is re-directed to the reflection region. In this case, it is advantageous in that the number of parts can be reduced.

Here, in the explanations of the present invention, an explanation is given with an example such that, the illumination portion has a wavelength distribution of light intensity, and also the human eye or image capturing portion at light-receiving side has wavelength sensitivity characteristics. However, as long as the illumination portion has wavelength characteristics of a certain value, it is sufficient if a wavelength sensitivity correction filter corresponding only to the wavelength sensitivity characteristics of light-receiving side is provided. For example, if the wavelength sensitivity characteristics have a peak at a certain wavelength, a wavelength sensitivity correction filter with a minimum value corresponding to the peak wavelength based on the wavelength sensitivity characteristics may be provided. Also, if the wavelength sensitivity characteristics of the light-receiving side are a certain value, it is sufficient if a wavelength sensitivity correction filter, which turns the illumination light to the white light whose wavelength characteristics are a certain intensity based on the wavelength distribution of the illumination light, is provided.

Also, in the above-described explanations, the position of the wavelength sensitivity correction filter is in the illumination portion. However, the wavelength sensitivity correction filter may be placed between the light source and the operator's eyes or an image capturing portion of light-receiving side, whereby an identical effect can be obtained.

Also, the wavelength distribution of the light source itself may correspond to the wavelength sensitivity characteristics of the human eye or image capturing portion of the light-receiving side. A case is considered in which the light source is constituted by a plurality of light sources provided with mutually different wavelengths, and the light quantity of each of the plurality of light sources varies independently. In this case, when the wavelength distribution of the light intensity is transmitted through the wavelength sensitivity characteristics of the human eye or an image capturing portion of the light-receiving side, light intensity of light sources of each of the wavelengths may be changed in order to make the peak light intensity substantially constant. In this case, the wavelength sensitivity correction filter can be omitted.

Also, if the laser light provided with a plurality of wavelengths explained above is employed as a light source, its wavelength characteristics become discrete. However, it is sufficient if the peak light intensities of each of the wavelengths of received wavelength lights become substantially constant based on the wavelength sensitivity characteristics. Using a light with a plurality of wavelengths and based on superpositions thereof reducing the influence of unevenness in the film of lower layers is an essence of the present invention. Therefore, by adjusting such that there is no wavelength whose intensity is significantly large relative to other wavelengths with respect to the wavelength sensitivity characteristics of the human eye or an image capturing portion of the light-receiving side, even when the wavelength characteristics are discrete, it is possible to reduce the influence of unevenness in the film of lower layers.

Also, in a case of using white color LEDs, it is also possible to initially design the wavelength distribution of irradiating light intensity such that light intensities in each of the wavelengths are substantially constant with respect to the wavelength sensitivity characteristics.

In a case of using a plurality of LEDs whose wavelengths are mutually different, for example three LEDs each of which has a peak in respective three RGB wavelength bands similar to the case of a laser light, it is sufficient if light intensities in each of the wavelengths are substantially constant with respect to the wavelength sensitivity characteristics by corresponding to the wavelength sensitivity characteristics of the human eye or an image capturing portion of light-receiving side. Since a LED has a larger bandwidth than a laser light, arranging light intensities in each of the wavelengths to the constant value is easier by superpositioning. The same as the case in which the laser light is used as a light source, even if there is some portion which is larger or smaller than the predicted intensity value in some wavelength regions, it is possible to reduce the influence of unevenness in the film of lower layers by adjusting such that there is no wavelength whose intensity is significantly large relative to other wavelengths. Because, by doing so, there is no risk of interrupting averaging the light intensity changes, due to the unevenness in the film of lower layers caused by certain strong wavelength.

Also, the same as the three chips CCD camera or the like, the image capturing portion may be constituted such that, a prism provided with a color separation filter is used and branches to a plurality of wavelengths such as RGB, and image capture them by a plurality of image capturing elements. At this time, relative to the signal outputs of the respective image capturing elements, if peak light intensity is arranged to be substantially constant based on the wavelength sensitivity characteristics, a wavelength sensitivity correction filter or arrangement for each of the wavelength regions on the light source side of the illumination become unnecessary. Therefore, arrangement is easier since it is sufficient to electrically adjust only the signal intensity from a plurality of image capturing elements.

Also, in the above-described explanations, an embodiment of using a flat mirror as a reflection element may be constituted by an aspherical mirror to correct deformations caused by other optical systems.

Also, in the above, as a wavelength sensitivity correction filter to change the wavelength distribution of the illumination light, the wavelength compensation plate, the wavelength compensation filter or the like is used. However, these wavelength sensitivity correction filters may be deleted if the necessary wavelength characteristics are obtained in a wavelength region necessary for the observation by the characteristics of the illumination portion and the image capturing portion.

Also, in the above, an explanation is given with an example of using the projection correction lens to correct deformations in images. However, by image processing the captured images and performing an interpolation between scanning lines, extension processing may be performed in accordance with the image deformation. In this case, it is preferable to use the projection correction lens as well since information quantity optically obtainable in the extension direction is different from the information quantity optically obtainable in a direction perpendicular to the extension direction.

Also, in the above-described constitutions and aspects of all embodiments and modification examples, if it is realizable, they may be arbitrarily combined and implemented within the scope of the present invention.

For example, in a case of inspecting a tested object formed with a multi-layer film, the following examples may be employed for a surface defect inspection apparatus to reduce unevenness in brightness or in color due to the influence of the lower layers and improve defect detection accuracy, even if there are differences in film thickness in the lower layers.

[1] A first example is a surface defect inspection apparatus which includes a retaining portion for retaining the tested object and provided with a flat portion, an illumination portion which generates the illumination light to illuminate the tested object, an irradiating optical system which irradiates the illumination light onto the tested object in a substantially constant direction, a re-entry optical system which returns a reflected light from the tested object to the reflection position of the tested object, and an image capturing portion which image captures the re-reflected light from the tested object due to the reflected light returned to the reflection position.

[2] Preferably, a second example is a surface defect inspection apparatus in accordance with the first example in which the image capturing portion includes a line image capturing portion which image captures the tested object as a line in which a longitudinal direction of a line image capturing region of the line image capturing portion is provided in a direction perpendicular to at least one axis direction of the irradiating optical system, and the retaining portion is movably provided in a direction in which the line image capturing portion intersects at right angle with the longitudinal direction of the line image capturing region.

[3] Preferably, a third example is a surface defect inspection apparatus in accordance with the first to second examples in which at least the irradiating optical system or the redirection optical system is retained by an angle varying mechanism which varies the angle position of the light axis relative to the surface of the tested object.

[4] Preferably, a fourth example is a surface defect inspection apparatus in accordance with the first to third examples in which a light received by the image capturing portion is corrected so that the output intensity of an image signal corresponding to the light intensity, the image capturing portion receives, is substantially constant with respect to the wavelength sensitivity characteristics of the image capturing portion.

Here, “corrected so that a light received by the image capturing portion is substantially constant with respect to the wavelength sensitivity characteristics of the image capturing portion” means that light received by the image capturing portion is corrected so that a signal output that the light intensity the image capturing portion receives is converted in accordance with the wavelength sensitivity characteristics inherent to the image capturing portion and becomes substantially flat (substantially constant) within a wavelength region in which the image capturing portion has sensitivity.

[5] Preferably, a fifth example is a surface defect inspection apparatus in accordance with the first to fourth examples in which the light that the image capturing portion receives has peaks at a plurality of wavelengths, and the light intensity the image capturing portion receives is corrected so that an output intensity of the image signal corresponding to the light intensity the image capturing portion receives, which in turn corresponds to the peak light intensity of the plurality of wavelengths, is substantially constant.

[6] Preferably, a sixth example is a surface defect inspection apparatus in accordance with the first to fifth examples in which the light intensity that the image capturing portion receives is corrected based on the wavelength sensitivity characteristics of the image capturing portion or the wavelength distribution of the illumination light.

[7] Preferably, a seventh example is a surface defect inspection apparatus in accordance with the first to sixth examples in which the output intensity of the image signal corresponding to the light intensity that the image capturing portion receives is corrected to be substantially constant by a wavelength sensitivity correction filter which corrects based on the wavelength sensitivity characteristics of the image capturing portion or the wavelength distribution of the illumination light.

[8] Preferably, an eighth example is a surface defect inspection apparatus in accordance with the first to seventh examples in which the light source of the illumination portion is formed of a plurality of light sources which have different wavelengths and whose respective light quantities is independently variable. Based on the wavelength sensitivity characteristics of the image capturing portion, the light intensity or the light quantity balance of the plurality of the light sources is changed so that the output intensity of the image signal corresponding to the light intensity that the image capturing portion receives is substantially constant.

[9] Preferably, a ninth example is a surface defect inspection apparatus in accordance with the first to eighth examples in which the wavelength distribution of the illumination light is corrected corresponding to the spectral luminous efficiency characteristics of the human eye for the purpose of being constituted to be visually observable and the light intensity an observer senses being substantially constant with respect to the wavelength sensitivity characteristics of the human eye.

[10] Preferably, a tenth example is a surface defect inspection apparatus in accordance with the first to ninth examples in which a light path for visual observation and the other light path for image capturing the image of the tested object irradiated by the illumination light are provided, and at the same time, a light path switching portion for switching the light path for visual observation and the other light path for image capturing is further provided in which the wavelength distribution of the illumination light is switched in synchronized by the switching operation of the light path switching portion.

[11] Preferably, an eleventh example is a surface defect inspection apparatus in accordance with the first to tenth examples in which a first polarization plate is provided in the light path between the light source of the illumination portion and the tested object, and a second polarization plate provided in a light path between the tested object and the human eye or the image capturing portion are further provided.

[12] Preferably, a twelfth example is a surface defect inspection apparatus in accordance with the first to eleventh examples in which an optical element provided with the power to elongate and contract the image of the tested object only in one direction is placed in such a light path that the illumination light is reflected from the tested object for the last time entering the human eye or the image capturing portion.

[13] Preferably, a thirteenth example is a surface defect inspection apparatus in accordance with the first to twelfth examples in which a translucent screen formed with a reference pattern to align the image of the tested object is placed between the tested object and the position where the visual observation is performed.

What is claimed is:

1. A surface defect inspection apparatus to perform visual observation or image capturing relative to a tested object which is irradiated with an illumination light to detect a surface defect of the tested object comprising:
the tested object,
a multi-layer film formed on the surface of the tested object, and
an illumination portion which irradiates the illumination light generated by a light source, wherein
the light intensity of the light irradiated from the illumination portion and received by the human eye, or the output intensity of an image signal corresponding to the light intensity received by the image capturing portion is corrected to be substantially constant with respect to the wavelength sensitivity characteristics of the human eye or the image capturing portion.

2. The surface defect inspection apparatus in accordance with claim 1, wherein
the light irradiated from the illumination portion has peaks in a plurality of wavelengths, and the light intensity irradiated from the illumination portion is corrected so that the intensity the human eye senses corresponding to the peak intensities of the plurality of wavelengths or output intensity of the image signal corresponding to the light intensity the image capturing portion receives is substantially constant.

3. The surface defect inspection apparatus in accordance with claim 1, wherein
the light intensity that the human eye sense relative to the light irradiated from the illumination portion and received by the human eye, or the light intensity the image capturing portion receives is corrected based respectively on the wavelength sensitivity characteristics of the human eye or the image capturing portion, or the wavelength distribution of the illumination light.

4. The surface defect inspection apparatus in accordance with claim 1, wherein
the light intensity the human eye senses relative to the light irradiated from the illumination portion and received by the human eye, or the output intensity of the image signal corresponding to the light intensity that the image capturing portion receives is corrected by a wavelength sensitivity correction filter which corrects based respectively on the wavelength sensitivity characteristics of the human eye or the image capturing portion, or the wavelength distribution of the illumination light.

5. The surface defect inspection apparatus in accordance with claim 1, wherein
the light source of the illumination portion is formed of a plurality of light sources, which have different wavelengths and respective light quantities are independently variable, and based on the wavelength sensitivity characteristics of the human eye or the image capturing portion, the light intensity or the light quantity balance of the plurality of the light sources is changed so that the light intensity the human eye senses relative the light irradiated from the illumination portion and received by the human eye, or the output intensity of the image signal corresponding to the light intensity the image capturing portion receives is substantially constant.

6. The surface defect inspection apparatus in accordance with claim 1, wherein
the wavelength distribution of the illumination light is corrected corresponding to spectral luminous efficiency characteristics of the human eye so that the light intensity the observer senses with respect to the wavelength sensitivity characteristics of the human eye is substantially constant.

7. The surface defect inspection apparatus in accordance with claim 1, further comprising:
a light path for visual observation,
the other light path for image capturing the image of the tested object irradiated by the illumination light, and
a light path switching portion for switching the light path for visual observation and the other light path for image capturing, wherein
the wavelength distribution of the illumination light is switched in synchronization with the switching operation of the light path switching portion.

8. The surface defect inspection apparatus in accordance with claim 1, further comprising:
a first polarization plate provided in a light path between the light source of the illumination portion and the tested object, and
a second polarization plate provided in a light path between the tested object and the human eye or the image capturing portion.

9. The surface defect inspection apparatus in accordance with claim 1, further comprising:
a re-reflection optical system provided with at least a reflection element in which the illumination light reflected by the tested object re-directs the position reflected on the tested object, wherein
a light reflected at the same position on the tested object two times or more is observable by the human eye or the image capturing portion.

10. The surface defect inspection apparatus in accordance with claim 1, further comprising:
an optical element which elongates and contracts the image of the tested object only in one direction in such a light path that the illumination light is reflected from the tested object for the last time and enters the human eye or the image capturing portion.

11. The surface defect inspection apparatus in accordance with claim 1, further comprising:
a translucent screen formed with a reference pattern to align the image of the tested object between the tested object and the position where the visual observation is performed.

12. The surface defect inspection apparatus in accordance with claim 1, wherein
the image capturing portion is a line image capturing portion which image captures the tested object as a line, and wherein
a retaining portion is movably provided in a perpendicular direction to a longitudinal direction of the line image capturing region of the line image capturing portion.

13. The surface defect inspection apparatus in accordance with claim 9, wherein
at least the illumination portion or the re-reflection optical system is retained by an angle varying mechanism which varies the angle position of the light axis relative to the surface of the tested object.
